(19) United States
(12) Patent Application Publication
(10) Pub. No.: US 2026/0080198 A1
(43) Pub. Date: Mar. 19, 2026

(54) RECORDING APPARATUS

(71) Applicant: CANON KABUSHIKI KAISHA, Tokyo (JP)

(72) Inventors: TAKESHI YAZAWA, Kanagawa (JP); HIDEHIKO KANDA, Kanagawa (JP); MASAKI NITTA, Kanagawa (JP); JUMPEI JOGO, Tokyo (JP); TAKAYUKI USHIYAMA, Chiba (JP); TAICHI YOKOKAWA, Kanagawa (JP)

(21) Appl. No.: 19/316,539

(22) Filed: Sep. 2, 2025

(30) Foreign Application Priority Data
Sep. 13, 2024 (JP) 2024-159227
Aug. 28, 2025 (JP) 2025-142202

(51) Int. Cl. G06K 15/02; B41J 2/21

(52) U.S. Cl. CPC G06K 15/1876; B41J 2/2103; B41J 2/2132; G06K 15/1881

(57) ABSTRACT

A recording apparatus includes one or more processors that operate to determine a dot arrangement of a plurality of colorant ink on a recording medium and a dot arrangement of a reaction solution on the recording medium based on respective dither patterns, a first dither pattern for determining a dot arrangement of a first colorant ink and a second dither pattern for determining a dot arrangement for the reaction solution, wherein a first number, which is a number of pixels overlapping between a first dot arrangement with gradation values smaller than a first median of first dither pattern gradations and a second dot arrangement with gradation values smaller than a second median of second dither pattern gradations, is greater than a second number, which is a number of pixels overlapping between a dot arrangement with gradation values greater than the first median and the second dot arrangement.

### BACKGROUND

### Field of the Technology

The present disclosure relates to one or more embodiments of a recording apparatus that records images on a recording medium using a reaction solution.

### Description of the Related Art

Inkjet recording apparatuses that record images on recording media by discharging ink from their recording heads to the recording media have been known. When such a recording apparatus records an image on a low-permeability recording medium, ink does not easily permeate the recording medium and remains on the recording medium. This causes bleeding between colorant ink droplets (hereinafter referred to as bleed) due to contact between adjacent different colorant ink droplets. To reduce this bleed, a technique using reaction solution ink (hereinafter, also referred to as reaction solution) that reacts with the colorants contained in the colorant inks has been known. More specifically, the colorant inks and reaction solution are brought into contact on the recording medium, whereby coagulation and the like of the colorants contained in the colorant inks are caused to reduce bleed. However, if the reaction solution is applied more than necessary, the boundaries between adjacent dots of reaction solution droplets may merge to connect the dots together (beading). When beading occurs, the image quality deteriorates significantly. Japanese Patent Laid-Open No. 9-109381 describes a technique for applying appropriate amounts of reaction solution to appropriate positions based on the application amounts and dot arrangements of colorant inks on a recording medium, which vary depending on the recording image data.

To reduce image defects such as density unevenness and textures, Japanese Patent Laid-Open No. 2007-306551 describes a technique for generating a mask pattern that prevents concentration of dot counts for respective recording scans on a certain scan and achieves favorable dot distribution within a specific area in consideration of overlap (logical products) with the dot arrangement patterns.

### SUMMARY

One or more embodiments of the present disclosure are directed to recording images with suppressed image defects due to beading and the like by bringing reaction solution dots into contact with colorant ink dots while suppressing image defects such as density unevenness and textures due to variations in the dot arrangements of the reaction solution for respective recording scans.

According to at least one aspect of the present disclosure, at least one embodiment of a recording apparatus may include a recording unit including a plurality of nozzle rows including a first nozzle row where a plurality of nozzles operating to apply colorant ink containing a colorant is arranged and a second nozzle row where a plurality of nozzles operating to apply a reaction solution to react with the colorant is arranged; and one or more processors that operate to: determine an amount of the colorant ink and an amount of the reaction solution to be applied to a recording medium based on input image data; and (i) determine a dot arrangement of the colorant ink based on the amount of the colorant ink and a first dither pattern corresponding to the colorant ink, and (ii) determine a dot arrangement of the reaction solution based on the amount of the reaction solution and a second dither pattern corresponding to the reaction solution, wherein a first number, which is a number of pixels overlapping between a dot arrangement with gradation values smaller than a median of all gradations in the first dither pattern and a dot arrangement with gradation values smaller than a median of all gradations in the second dither pattern, is greater than a second number, which is a number of pixels overlapping between a dot arrangement with gradation values greater than the median of all the gradations in the first dither pattern and the dot arrangement with the gradation values smaller than the median of all the gradations in the second dither pattern.

According to other aspects of the present disclosure, one or more additional recording apparatuses, one or more methods, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating the appearance of at least one embodiment of a recording apparatus in accordance with one or more aspects of the present disclosure.

FIG. 2 is a side view of a main body of at least one embodiment of a recording apparatus in accordance with one or more aspects of the present disclosure.

FIG. 3 is a diagram illustrating at least one embodiment of a recording head in accordance with one or more aspects of the present disclosure.

FIG. 4 is a block diagram illustrating a schematic configuration of at least one embodiment of a recording system including a host apparatus and an internal control system of the recording apparatus in accordance with one or more aspects of the present disclosure.

FIG. 5 is a block diagram for describing at least one embodiment of a procedure of image data conversion processing in accordance with one or more aspects of the present disclosure.

FIGS. 6A to 6F are schematic diagrams illustrating one or more embodiments of color dither patterns and one or more embodiments of reaction solution dither patterns in accordance with one or more aspects of the present disclosure.

FIGS. 7A to 7F are schematic diagrams illustrating one or more embodiments of color dot arrangements and one or more embodiments of reaction solution dot arrangements in accordance with one or more aspects of the present disclosure.

FIGS. 8A to 8H are schematic diagrams illustrating one or more embodiments showing overlapping of color dots and reaction solution dots in accordance with one or more aspects of the present disclosure.

FIG. 9A to 9I are schematic diagrams illustrating one or more embodiments of color dot arrangements and at least one embodiment of a reaction solution dot arrangement in accordance with one or more aspects of the present disclosure.

FIGS. 10A to 10H are schematic diagrams illustrating one or more embodiments showing overlapping of color dots and reaction solution dots in accordance with one or more aspects of the present disclosure.

FIGS. 11A and 11B are schematic diagrams illustrating one or more embodiments of reaction solution mask patterns in accordance with one or more aspects of the present disclosure.

FIGS. 12A to 12C are schematic diagrams illustrating one or more embodiments of dot arrangements during recording scans of the reaction solution in accordance with one or more aspects of the present disclosure.

FIG. 13 is a flowchart illustrating at least one embodiment of a method for generating a reaction solution dither pattern in accordance with one or more aspects of the present disclosure.

FIG. 14 is a schematic diagram illustrating at least one embodiment that may be used with the at least one embodiment of the method for generating a reaction solution dither pattern in accordance with one or more aspects of the present disclosure.

FIG. 15 is a schematic diagram illustrating at least one embodiment of a reaction solution dither pattern in accordance with one or more aspects of the present disclosure.

FIG. 16A is a flowchart illustrating at least one embodiment of a method for generating a reaction solution dither pattern in accordance with one or more aspects of the present disclosure.

FIG. 16B is a flowchart illustrating at least one embodiment of a method for generating a reaction solution dither pattern in accordance with one or more aspects of the present disclosure.

FIGS. 17A to 17D are schematic diagrams illustrating one or more embodiments of colorant ink dither patterns in accordance with one or more aspects of the present disclosure.

FIGS. 18A to 18C are schematic diagrams illustrating one or more embodiments that may be used with at least one embodiment of a method for generating a reaction solution dither pattern in accordance with one or more aspects of the present disclosure.

FIG. 19 is a schematic diagram illustrating at least one embodiment of a reaction solution dither pattern in accordance with one or more aspects of the present disclosure.

FIG. 20A is a flowchart illustrating at least one embodiment of a method for generating a reaction solution dither pattern in accordance with one or more aspects of the present disclosure.

FIG. 20B is a flowchart illustrating at least one embodiment of a method for generating a reaction solution dither pattern in accordance with one or more aspects of the present disclosure.

FIG. 20C is a flowchart illustrating at least one embodiment of a method for generating a reaction solution dither pattern in accordance with one or more aspects of the present disclosure.

FIG. 20D is a flowchart illustrating at least one embodiment of a method for generating a reaction solution dither pattern in accordance with one or more aspects of the present disclosure.

FIG. 21 is a graph illustrating the amounts of color inks and reaction solution used in one or more embodiments of the present disclosure.

FIG. 22 is a graph illustrating the amounts of color inks and reaction solution used in one or more embodiments of the present disclosure.

### DESCRIPTION OF THE EMBODIMENTS

Embodiments of the present disclosure will be described in detail below with reference to the attached drawings.

### Configuration(s) for One or More Embodiments

One or more basic configurations of an inkjet recording apparatus according to one or more embodiments will initially be described.

### (1) Configuration(s) of One or More Embodiments of an Inkjet Recording Apparatus

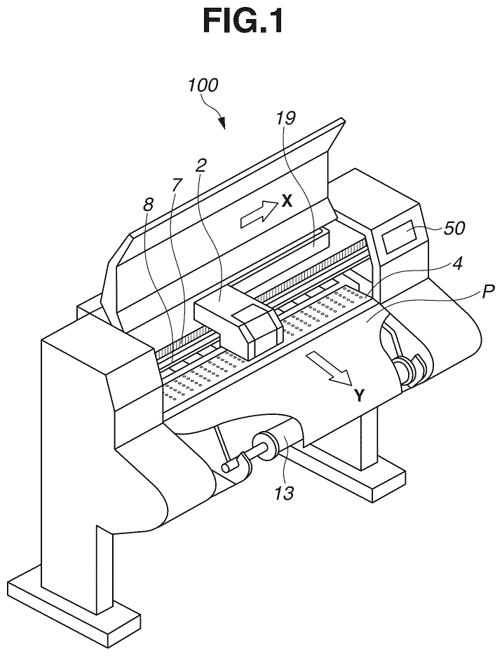

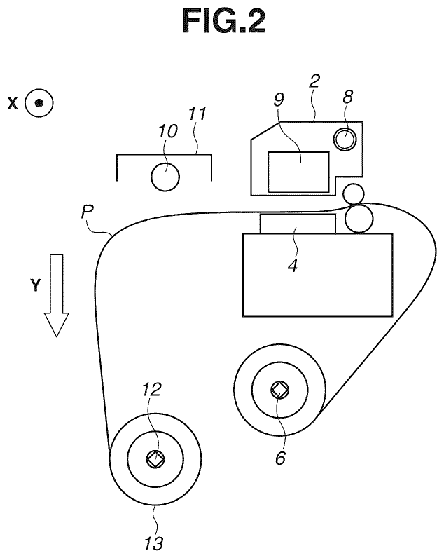

FIG. 1 is a diagram illustrating the appearance of the inkjet recording apparatus (hereinafter, also referred to as recording apparatus or printer) according to one or more embodiments of the present disclosure. A recording apparatus 100 of FIG. 1 is a serial scanning printer, and records an image by scanning its recording head in an X direction (scanning direction) orthogonal to a Y direction (conveyance direction) of a recording medium P. FIG. 2 is a side view of a main body of the recording apparatus 100.

At least one configuration and recording operation of the recording apparatus 100 will be overviewed with reference to FIGS. 1 and 2. Initially, the recording medium P is conveyed in the Y direction from a spool 6 holding the recording medium P by a conveyance roller that is driven by a not-illustrated conveyance motor via gears. Meanwhile, at a predetermined conveyance position, a carriage unit 2 is scanned to reciprocate (is reciprocated) along a guide shaft 8 extending in the X direction by a not-illustrated carriage motor. In this scanning process, nozzles of a recording head 9 (to be described below) detachably attached to the carriage unit 2 are caused to perform discharge operation at timing based on a position signal obtained by an encoder 7, whereby recording is performed for a fixed band width corresponding to the range where the nozzles are arranged. In one or more embodiments, the carriage unit 2 is configured to scan at a scanning speed of 30 inches per second and perform the discharge operation at a recording resolution of 1200 dpi (1/1200-inch pitch). The recording medium P is then conveyed and the next band width of image is further recorded.

A carriage belt may be used to transmit the driving force from the carriage motor to the carriage unit 2. Instead of the carriage belt, other driving methods may be used. Examples include a driving mechanism including a lead screw that is driven to rotate by the carriage motor and extends in the X direction and an engagement unit that is disposed on the carriage unit 2 and engages with the thread of the lead screw.

The fed recording medium P is nipped and conveyed by a feed roller and a pinch roller, and guided to a recording position on a platen 4 (scanning area of the recording head 9). In an idle state, the face surface of the recording head 9 is usually capped. The cap is thus opened to make the recording head 9 (carriage unit 2) scannable prior to recording. Data for one scan is then accumulated in a buffer, and the carriage unit 2 is scanned by the carriage motor to perform recording in the foregoing manner.

A flexible wiring board 19 for supplying driving pulses, head temperature control signals, and the like for discharge driving is attached to the recording head 9. The other end of the flexible wiring board 19 is connected to a control unit (not illustrated) including a control circuit, such as a central processing unit (CPU), that controls this recording apparatus 100. A user interface (UI) screen 50 is configured so that the user may input or check cancellation of the recording operation, information about the recording medium P, and the like.

A heater 10 supported by a not-illustrated frame is located in a curing area downstream of the position in the Y direction (sub scanning direction Y) where the recording head 9 attached to the carriage unit 2 is scanned to reciprocate in the X direction (main scanning direction X). The heater 10 thermally dries liquid ink on the recording medium P. The heater 10 is covered by a heater cover 11. The heater cover 11 has a function of efficiently radiating the heat of the heater 10 to the recording medium P and a function of protecting the heater 10. After the recording by the recording head 9, the recording medium P is wound up by a take-up spool 12 to form a roll of wound medium 13. Specific examples of the heater 10 include a sheath heater and a halogen heater. The heating temperature of the heating section in the curing area is set in consideration of the film formability and productivity of water-soluble resin fine particles and the heat resistance of the recording medium P. Hot air heating from above, contact-type thermal conduction heater heating from below the recording medium P, or the like may be used as the heating means of the heater 10 in the curing area. In one or more embodiments, the heating means of the heating section in the curing area is described to be disposed at one location. However, heating means may be disposed at two or more locations as long as the temperature on the recording medium P measured by a radiation thermometer (not illustrated) does not exceed the set value of the heating temperature.

The recording apparatus 100 according to one or more embodiments may perform multi-pass recording, in which an image is recorded on a predetermined area (1/n band) on the recording medium P by multiple (n times of) scans of the recording head 9.

### (2) One or More Configurations of Recording Head

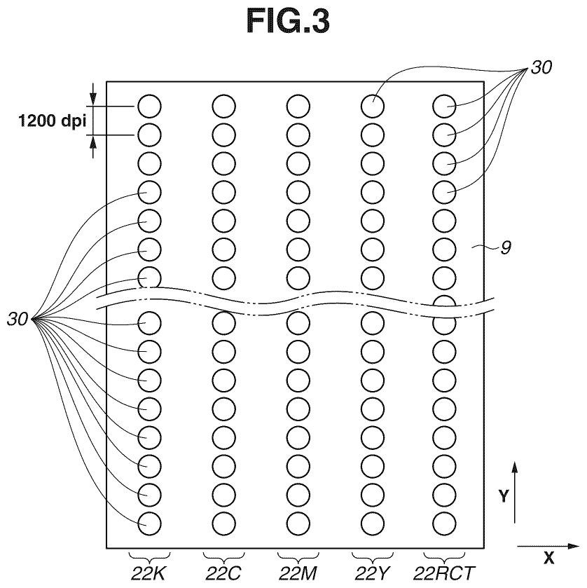

FIG. 3 is a diagram illustrating the recording head 9 according to one or more embodiments. The recording head 9 includes a nozzle row 22K for discharging black ink (K), a nozzle row 22C for discharging cyan ink (C), a nozzle row 22M for discharging magenta ink (M), and a nozzle row 22Y for discharging yellow ink (Y) as inks containing colorants. In the following description, the black ink (K), cyan ink (C), magenta ink (M), and yellow ink (Y) are also referred to simply as colorant inks since these inks contain respective colorants.

The recording head 9 also includes a nozzle row 22RCT for discharging reaction solution ink (RCT) containing no colorant. This reaction solution ink (hereinafter, also referred to as reaction solution) does not contain any colorant but contains reactive components that react with the colorants contained in the colorant inks. The reaction solution ink may reduce bleed through contact with the colorant inks on the recording medium P.

Each nozzle row includes nozzles arranged in the sub scanning direction. In one or more embodiments of the recording head 9, the nozzle rows are arranged in order of the nozzle rows 22K, 22C, 22M, 22Y, and 22RCT from left to right in the main scanning direction (X direction) intersecting the sub scanning direction. The nozzle rows 22K, 22C, 22M, 22Y, and 22RCT each include 1280 nozzles 30 that discharge the corresponding ink, arranged in the Y direction (array direction, sub scanning direction) at a density of 1200 dpi. In one or more embodiments, the amount of ink discharged from one nozzle 30 at a time is approximately 5 pl.

The nozzle rows 22K 22C, 22M, 22Y, and 22RCT are connected to not-illustrated ink tanks storing the respective corresponding inks for ink supply. The recording head 9 and the ink tanks used in one or more embodiments may be integrally configured, or configured to be individually separable.

Detailed compositions of the black ink (K), cyan ink (C), magenta ink (M), yellow ink (Y), and reaction solution (RCT) will be described below. Water-soluble resin fine particles that thermally form a film to improve the abrasion resistance of the recorded product may be contained in each of the colorant inks, or in clear emulsion ink (Em) that is a third ink not containing any colorant and different from the colorant inks or the reaction solution. In the latter case, the recording head 9 may include a nozzle row 22Em that discharges the clear emulsion ink.

(3) One or more Configurations of Recording System

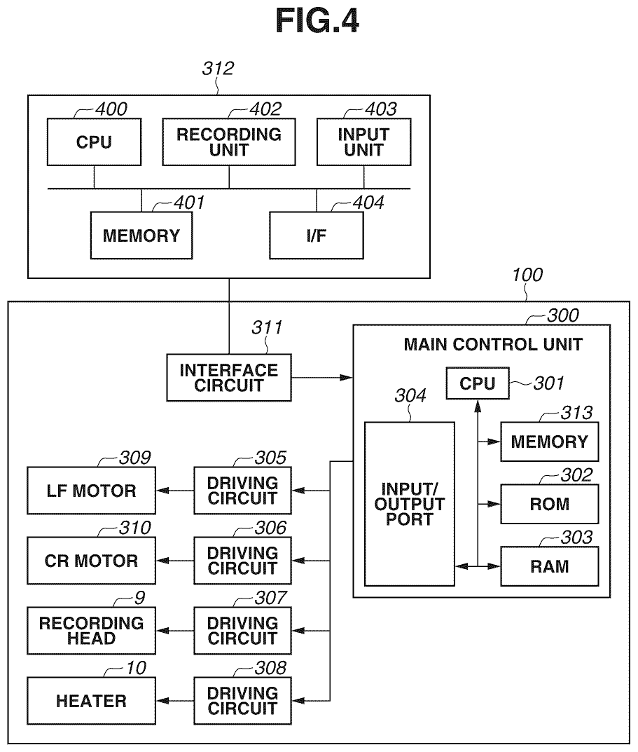

FIG. 4 is a block diagram illustrating a schematic configuration of a recording system including a host apparatus 312 and an internal control system of the recording apparatus 100 according to one or more embodiments. The host apparatus 312 is an information processing apparatus connected to the recording apparatus 100. Examples include a personal computer and a digital camera. The host apparatus 312 includes a CPU 400, a memory 401, a storage unit 402, an input unit 403 such as a keyboard and a mouse, and an interface 404 for communication with the recording apparatus 100. The CPU 400 performs various types of processing based on programs stored in the memory 401. The programs are supplied for the storage unit 402 to store from an external storage medium such as a Compact Disc Read-Only Memory (CD-ROM). The programs may be stored in the storage unit 402 in advance.

The host apparatus 312 is connected to the recording apparatus 100 via the interface 404, and transmits image processing information to the recording apparatus 100. The image processing information includes image data expressed in red (R), green (G), and blue (B) for use in an image processing step or steps to be described below, and tables (recording control information) for use in subsequent image processing. The recording apparatus 100 performs image processing such as color processing and binarization processing to be described below, as well as recording characteristic correction processing and the like, based on the transmitted image processing information. The host apparatus 312 may perform at least part of the color processing, image processing, and correction processing.

The recording apparatus 100 includes a main control unit 300. The main control unit 300 includes a CPU 301 that performs calculation, selection, determination, control, and other processing operations, as well as recording operations. The main control unit 300 also includes a read-only memory (ROM) 302 storing control programs and the like to be executed by the CPU 301, a random access memory (RAM) 303 to be used as a recording data buffer and the like, and an input/output port 304. The memory 313 stores mask patterns and the like to be described below. The input/output port 304 is connected with driving circuits 305, 306, 307, and 308 such as actuators for a conveyance motor (line feed [LF] motor) 309, a carriage (CR) motor 310, the recording head 9, the heater 10, etc. The main control unit 300 is connected to the host apparatus 312 via an interface circuit 311.

### (4) One or More Configurations of a Recording Medium

The recording apparatus 100 according to one or more embodiments performs recording on a low-permeability recording medium that moisture does not easily permeate. As employed herein, a low-permeability recording medium refers to a medium that either has no water absorbency or absorbs an extremely small amount of water. Aqueous inks containing no organic solvents are therefore repelled and unable to form images. On the other hand, low-permeability recording media have excellent water resistance and weather resistance, and are suitable as media for forming recorded products for outdoor use. Typically, recording media having a water contact angle of 45° or more at 25° C. are used as low-permeability recording media. The water contact angle may be 60° or more.

Low-permeability recording media include those having a plastic layer formed on the outermost surface of their substrate, and those having no ink receiving layer formed on their substrate. Other examples include glass, Yupo, and plastic sheets, films, and banners. Examples of the plastic include polyvinyl chloride, polyethylene terephthalate, polycarbonate, polystyrene, polyurethane, polyethylene, and polypropylene. Such low-permeability recording media have excellent water resistance, light resistance, and abrasion resistance, and are thus typically used in forming recorded products for outdoor display.

### (5) Ink Composition(s)

### Overview of Ink Composition(s)

Details of the inks constituting the ink set used in one or more embodiments will be described. In the following description, “parts” and “%” are on a mass basis unless otherwise specified.

### (5-1) Compositions of Inks

The compositions of the inks will now be described in detail. The colorant inks (C, M, Y, K) and reaction solution (RCT) used in one or more embodiments each contain a water-soluble organic solvent. In view of wettability and moisture retention of the face surface of the recording head 9, the water-soluble organic solvents may have a boiling point of 150° C. or higher and 300° C. or lower. From the viewpoint of the function as a film-forming aid for resin fine particles and the swelling and dissolving properties to recording media on which resin layers are formed, the following substances may be used in particular. The usable substances include ketone compounds such as acetone and cyclohexanone, ethylene glycol derivatives such as tetraethylene glycol dimethyl ether, and heterocyclic compounds having a lactam structure, typified by N-methylpyrrolidone and 2-pyrrolidone. In view of discharge performance, the content of water-soluble organic solvents may be 3 wt % or more and 30 wt % or less. Water-soluble organic solvents may be used singly or in combination. Deionized water may be used as the water. The content of water-soluble organic solvents in the reaction solution (RCT) is not limited in particular. To provide desired physical properties, surfactants, defoaming agents, preservatives, or antifungal agents may be added to the colorant inks (C, M, Y, K) as appropriate in addition to the foregoing components.

Surfactants are used as penetrants to improve ink penetration to recording media dedicated to inkjet recording. The greater the amount of surfactant added, the stronger the property of reducing the surface tension of the ink and the more improved the wettability and permeability of the ink to the recording medium.

The inks according to one or more embodiments are all alkaline and stable in pH, ranging from 8.5 to 9.5 in value. From the viewpoint of reducing elution and deterioration of members that contact the inks inside the recording apparatus 100 or the recording head 9, as well as a decrease in the solubility of dispersed resin in the inks, the pH of each ink may be 7.0 or higher and 10.0 or lower. The colorant inks may include white ink (W).

### (5-2) Reaction Solution(s)

In one or more embodiments, to solve bleed and other image-related issues, a reaction solution for insolubilizing some or all of solid components of the colorant inks is employed.

Examples of the reaction solution for insolubilizing dissolved dyes or dispersed pigments and resins include solutions containing polyvalent metal ions (such as magnesium nitrate, magnesium chloride, aluminum sulfate, and iron chloride). As a type of flocculation using such cations, systems used in low molecular weight cationic polymer flocculants may also be used for the purposes of charge neutralization of water-soluble resin fine particles and insolubilization of anionic soluble substances.

Among other reaction systems is an insolubilization system using a reaction solution that utilizes pH differences.

As described above, most of colorant inks commonly used for inkjet recording are alkaline and stable due to the properties of the colorants and the like, typically with a pH of 7 to 10 or so. The pH is often set to approximately 8.5 to 9.5 from an industrial standpoint or in consideration of external environmental impact and the like. To flocculate and solidify colorant inks of such systems, an acidic solution may be added to change the pH and disrupt the stable state so that the dispersed components aggregate. For such purposes, acidic solutions may be used as the reaction solution.

### (5-3) Water-Soluble Resin Fine Particles

The colorant inks used in one or more embodiments contain water-soluble resin fine particles. In one or more embodiments, “water-soluble resin fine particles” refer to polymer fine particles that exist in a state of being dispersed in water. The water-soluble resin fine particles may be core-shell type resin fine particles that are resin fine particles constituted by core parts and shell parts of different polymer compositions, or resin fine particles obtained by using pre-synthesized acrylic fine particles as seed particles for particle size control and causing emulsion polymerization around the seed particles. Hybrid resin file particles formed by chemically bonding different resin fine particles, such as acrylic resin fine particles and urethane resin fine particles, may be used.

The water-soluble resin fine particles do not necessarily need to be contained in the colorant inks, and may be contained in clear emulsion ink (Em) that is the third ink not containing any colorant and different from the colorant inks or reaction solution.

### (6) Image Processing

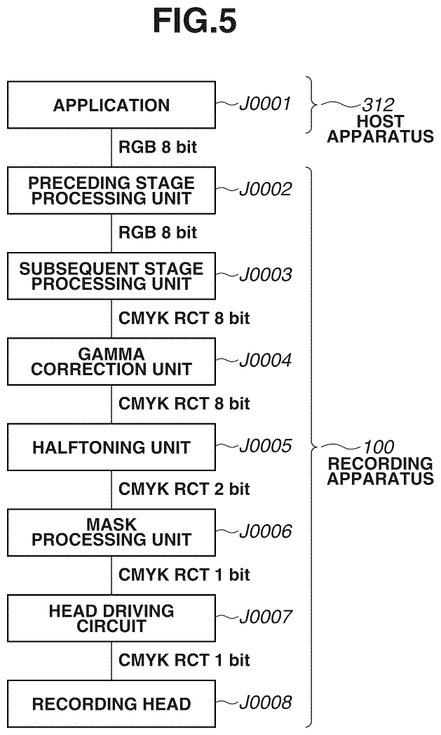

FIG. 5 is a block diagram for describing the procedure of image data conversion processing according to one or more embodiments.

FIG. 5 illustrates the procedure of image processing for converting input image data expressed by RGB colors in 8 bits (256 gradation levels) each, input to the recording apparatus 100, into 1-bit data for respective ink colors, and outputting the converted data. This recording system includes the host apparatus 312 and the recording apparatus 100.

The host apparatus 312 is a personal computer (PC), for example, and includes an application J0001 and a printer driver (not illustrated) for the recording apparatus 100 according to one or more embodiments. The application J0001 performs processing for generating image data to be delivered to the printer driver and processing for setting recording control information for recording control, based on information specified by the user on a UI screen of the host apparatus 312.

The image data and recording control information processed by the application J0001 are delivered to the printer driver at the time of recording. The main control unit 300 of the recording apparatus 100 performs image processing on the image data transferred from the host apparatus 312 on which the printer driver is installed, via the interface circuit 311.

The main control unit 300 includes a preceding state processing unit J0002, a subsequent stage processing unit J0003, a gamma correction unit J0004, and a halftoning unit J0005 as components for performing image processing. These units are implemented by the CPU 301 of the main control unit 300 executing programs stored in the ROM 302, the memory 313, or the like. The functions of some or all of the units may be implemented by hardware such as an application-specific integrated circuit (ASIC) and an electronic circuit. Each process will now be briefly described.

The preceding stage processing unit J0002 performs gamut mapping. This process performs data conversion to map the gamut to be reproduced by sRGB standard image data (R, G, B) into a gamut to be reproduced by the recording apparatus 100. Specifically, 256-level data expressing R, G, and B values in 8 bits each is converted into 8-bit R, G, B data (RGB values) of a different gamut using a three-dimensional lookup table (LUT).

The subsequent stage processing unit J0003 converts the R, G, B data gamut-mapped by the preceding stage processing unit J0002 into 8-bit color separation data indicating combinations of inks for reproducing the color expressed by the R, G, B data, based on a three-dimensional LUT for subsequent stage processing. In one or more embodiments, C, M, Y, and K, four color inks are used as the colorant inks. The subsequent stage processing unit J0003 thus converts the R, G, B data into color separation data indicating combinations of these ink colors. Like the preceding stage processing unit J0002, the subsequent stage processing unit J0003 here performs the conversion using the three-dimensional LUT along with interpolation calculation. The subsequent stage processing unit J0003 also generates 8-bit color separation data for the reaction solution (RCT) in the combinations of inks. In other words, the subsequent stage processing unit J0003 converts the R, G, B data into C, M, Y, K, RCT color separation data.

The gamma correction unit J0004 performs color-by-color density value (gradation value) conversion on the color separation data for each color, determined by the subsequent stage processing unit J0003. Specifically, the gamma correction unit J0004 performs conversion to linearly associate the color separation data with the gradation characteristics of the recording apparatus 100, using one-dimensional LUTs.

The halftoning unit J0005 performs quantization processing for converting the pieces of gamma-corrected 8-bit color separation data for the respective colors into 1-bit data. In one or more embodiments, the 256-level 8-bit data is converted (binarized) into “1” or “0”, 1-bit data using a dither method. Binary data as to whether the recording apparatus 100 discharges ink may thereby be obtained. The quantization processing will be described in detail below.

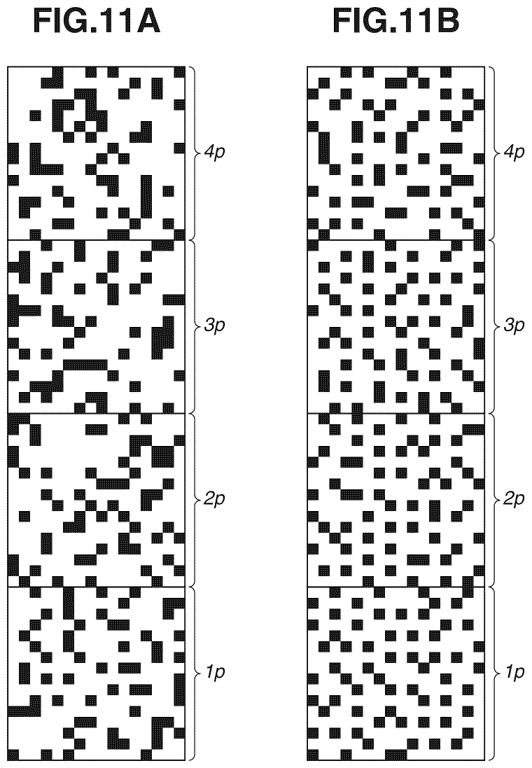

The mask processing unit J0006 performs mask processing on the dot arrangements of the respective colors determined by the halftoning unit J0005, using a plurality of mutually complementary mask patterns. Recording data on each recording scan in multi-pass recording is thereby generated for each of the C, M, Y, K, and RCT colors. FIGS. 11A and 11B illustrate reaction solution mask patterns, which are mask patterns for completing an image in four recording scans. The filled pixels in FIGS. 11A and 11B represent recordable pixels. The areas denoted by 1P, 2P, 3P, and 4P represent the mask patterns corresponding to the respective scans, which are mutually complementary.

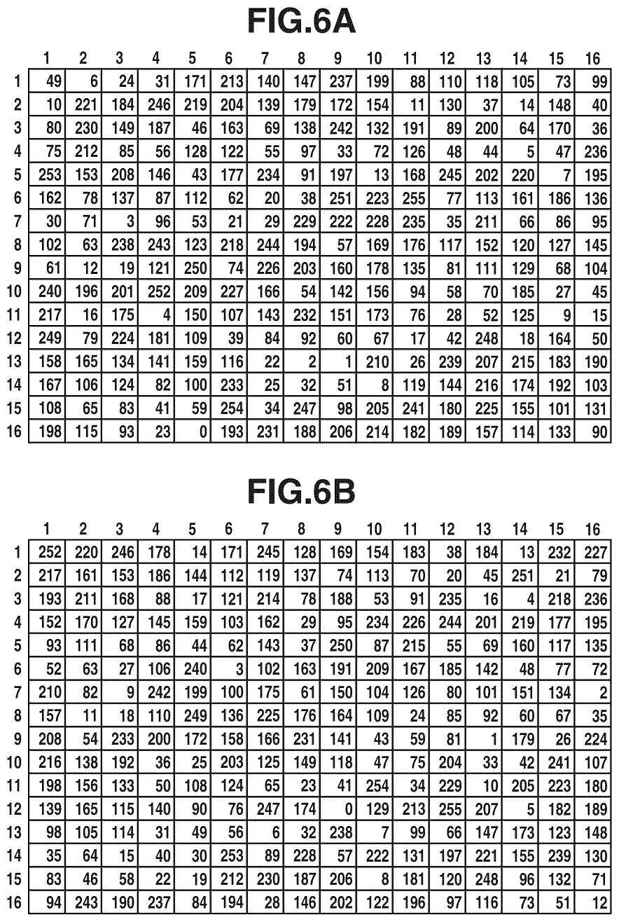

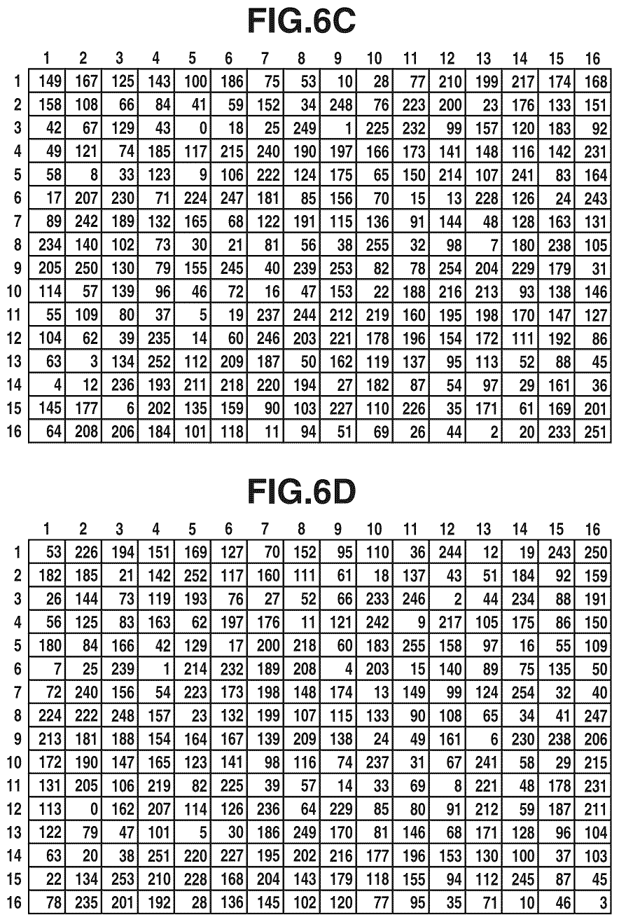

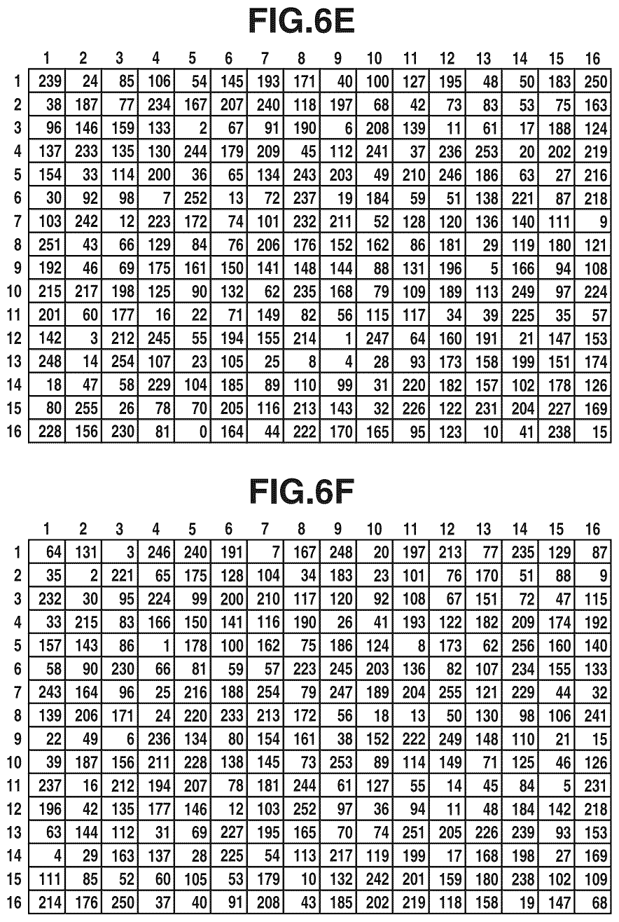

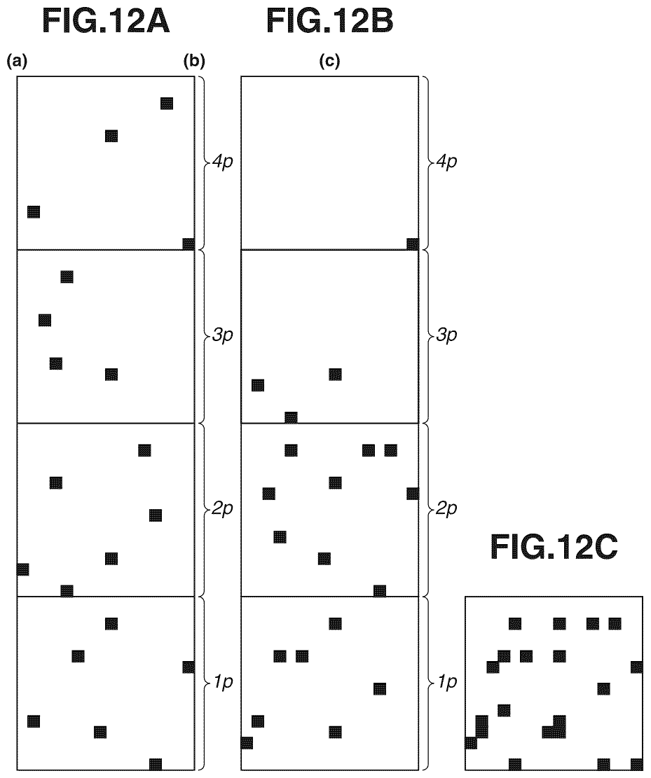

FIG. 11A illustrates the reaction solution mask patterns according to one or more embodiments, where interference with the reaction solution dither pattern illustrated in FIG. 6E is reduced. The method for generating mask patterns with reduced interference between the dither pattern and the mask patterns follows the method described in Japanese Patent Laid-Open No. 2007-306551, and the arrangements of recordable pixels are generated in consideration of overlap (logical products) with the dot arrangement determined by the dither pattern. In other words, the distribution of recordable pixels in the mask patterns, when overlapped with the dot arrangement, includes less low-frequency components and is favorably dispersed. For the sake of comparison of the interference reduction effect, FIG. 11B illustrates comparative mask patterns generated without the interference reduction processing with the dither pattern. FIG. 12C illustrates the dot arrangement when a uniform solid image of 20/255 gradation is input as a reaction solution input image according to one or more embodiments. FIGS. 12A and 12B illustrate the dot arrangements for respective scans, developed using the mask pattens of FIGS. 11A and 11B on the dot arrangement of FIG. 12C. In FIGS. 12A and 12B, the areas denoted by 1P, 2P, 3P, and 4P represent the dot arrangements corresponding to the respective scans. It may be seen that the dot arrangements for the respective scans of FIG. 12B, developed using the comparative mask patterns of FIG. 11B generated without the interference reduction processing with the dither pattern, vary significantly in the number of reaction solution dots applied by each scan. By contrast, FIG. 12A illustrates the dot arrangements for the respective scans, developed using the mask patterns of FIG. 11A generated with the interference reduction processing with the dither pattern according to one or more embodiments. It may be seen that the dot arrangements of FIG. 12A do not vary much in the number of reaction solution dots applied by each scan. The dot data for respective scans generated by the mask processing using the mask patterns generated with the interference reduction processing with the dither pattern is thus favorably dispersed within a specific area without the number of reaction solution dots being concentrated on a specific scan. Such favorable dispersion suppresses image defects such as density unevenness and textures.

The generated recording data is supplied to the head driving circuit J0007 at appropriate timing during a plurality of recording scans performed in multi-pass recording. The recording data input to the head driving circuit J0007 is then converted into driving pulses for the recording head J0008 (recording head 9), and the inks are discharged from the nozzles 30 of the respective colors at predetermined timing. This implements ink discharge based on the recording data, whereby an image is recorded on the recording medium P.

In the example of FIG. 5, the preceding stage processing unit J0002 and the subsequent processing units are described to be implemented by the recording apparatus 100. However, some of the processing units may be implemented by the printer driver of the host apparatus 312 and the like.

### (7) Quantization Processing

Next, the quantization processing will be described. FIGS. 6A to 6E are diagrams illustrating color and reaction solution dither patterns used in dither processing that is the quantization processing method according to one or more embodiments. FIG. 6A illustrates a cyan dither pattern, FIG. 6B a magenta dither pattern, FIG. 6C a yellow dither pattern, FIG. 6D a black dither pattern, and FIG. 6E a reaction solution dither pattern. As illustrated in FIGS. 6A to 6E, the dither patterns according to one or more embodiments are patterns including thresholds of 0 to 255 set for 16 columns×16 rows of pixels. The quantization processing is performed by vertically and horizontally tiling the dither patterns. Data of 0 to 255 is input to each pixel of each color, and compared with the threshold of the corresponding pixel in the dither pattern. If the input data is greater than the threshold, “1” is output (dot data is generated), and if the input data is less than or equal to the threshold, “0” is output (no dot data is generated), whereby a pseudo-halftone image is expressed.

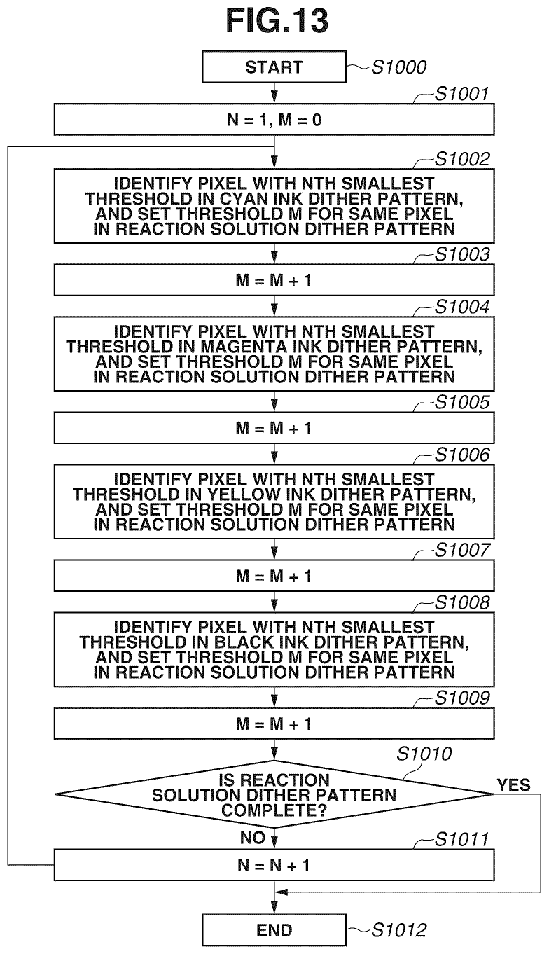

In one or more embodiments, to increase the contact probability between the colorant ink dots and the reaction solution dots, the reaction solution dither pattern is generated by assigning thresholds to the reaction solution dither pattern in ascending order, starting at pixel positions where the dither thresholds for the colorant inks are smaller. At least one embodiment of a specific generation method will now be described with reference to the flowchart of FIG. 13.

In step S1000, the halftoning unit J0005 starts generation of the reaction solution dither pattern. In step S1001, the halftoning unit J0005 sets natural numbers N and M to “1” and “0”, respectively. In step S1002, the halftoning unit J0005 identifies the pixel with the Nth (N=1) smallest threshold in the cyan ink dither pattern, and sets a threshold M (=0) for the pixel at the same position in the reaction solution dither pattern. The pixel with the smallest threshold “0” in the cyan ink dither pattern of FIG. 6A is located at (column 5, row 16), based on which the smallest threshold “0” in the reaction solution dither pattern of FIG. 6E is set at (column 5, row 16). In step S1003, the halftoning unit J0005 increases the value of natural number M by 1. In step S1004, the halftoning unit J0005 identifies the pixel with the Nth (N=1) smallest threshold in the magenta ink dither pattern, and sets the threshold M (=1) for the pixel at the same position in the reaction solution dither pattern. The pixel with the smallest threshold “0” in the magenta ink dither pattern of FIG. 6B is located at (column 9, row 12), based on which the second smallest threshold “1” in the reaction solution dither pattern of FIG. 6E is set at (column 9, row 12). In step S1005, the halftoning unit J0005 increases the value of natural number M by 1. In step S1006, the halftoning unit J0005 identifies the pixel with the Nth (N=1) smallest threshold in the yellow ink dither pattern, and sets the threshold M (=2) for the pixel at the same position in the reaction solution dither pattern. The pixel with the smallest threshold “0” in the yellow ink dither pattern of FIG. 6C is located at (column 5, row 3), based on which the third smallest threshold “2” in the reaction solution dither pattern of FIG. 6E is set at (column 5, row 3).

In step S1007, the halftoning unit J0005 increases the value of natural number M by 1. In step S1008, the halftoning unit J0005 identifies the pixel with the Nth (N=1) smallest threshold in the black ink dither pattern, and sets the threshold M (=3) for the pixel at the same position in the reaction solution dither pattern. The pixel with the smallest threshold “0” in the black ink dither pattern of FIG. 6D is located at (column 2, row 12), based on which the fourth smallest threshold “3” in the reaction solution dither pattern of FIG. 6E is set at (column 2, row 12). In step S1009, the halftoning unit J0005 increases the value of natural number M by 1. In step S1010, if the reaction solution dither pattern is complete (YES in step S1010), the processing proceeds to step S1012 and ends. If not (NO in step S1010), the processing returns to step S1002. More specifically, the halftoning unit J0005 subsequently similarly identifies the positions of the thresholds for the respective colorant inks in ascending order, like the second smallest threshold for cyan “1”, the second smallest threshold for magenta “1”, the second smallest threshold for yellow “1”, the second smallest threshold for black “1”, and so on, and sets thresholds at the same positions in the reaction solution dither pattern of FIG. 6E in ascending order.

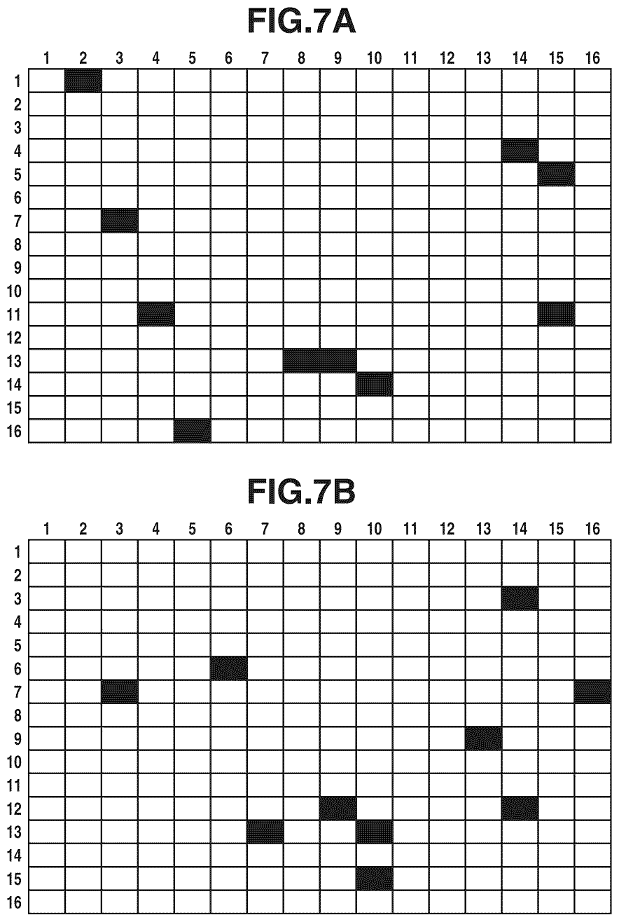

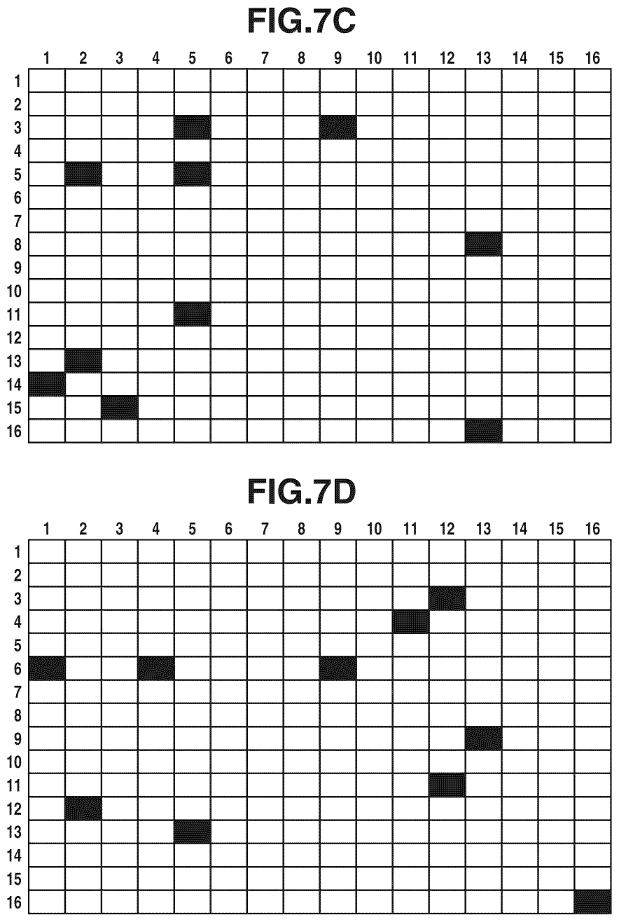

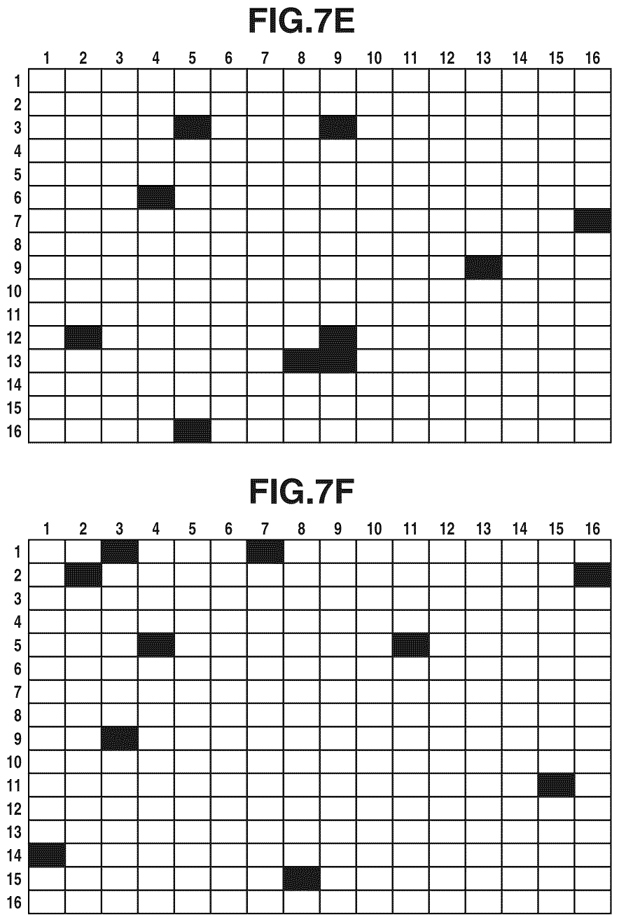

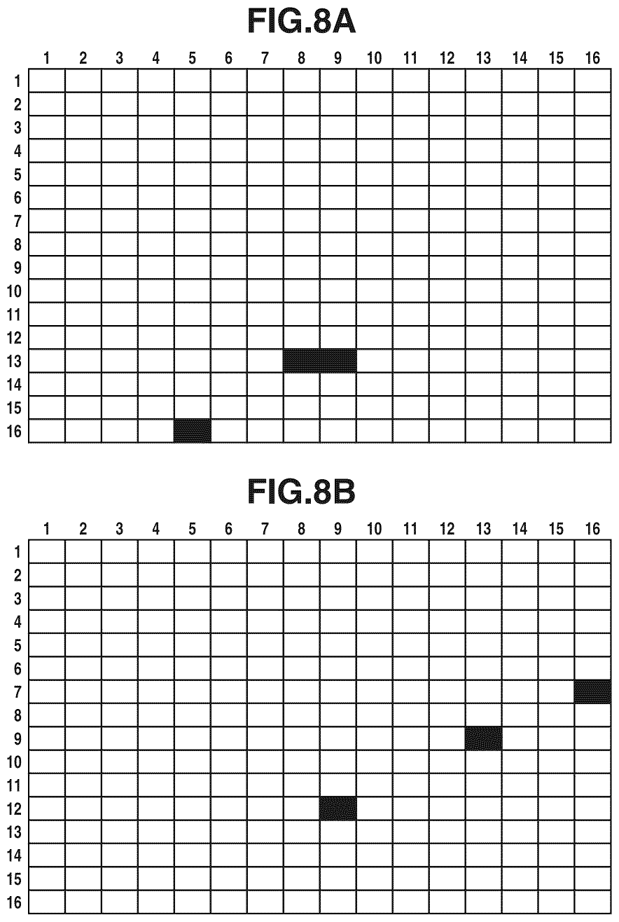

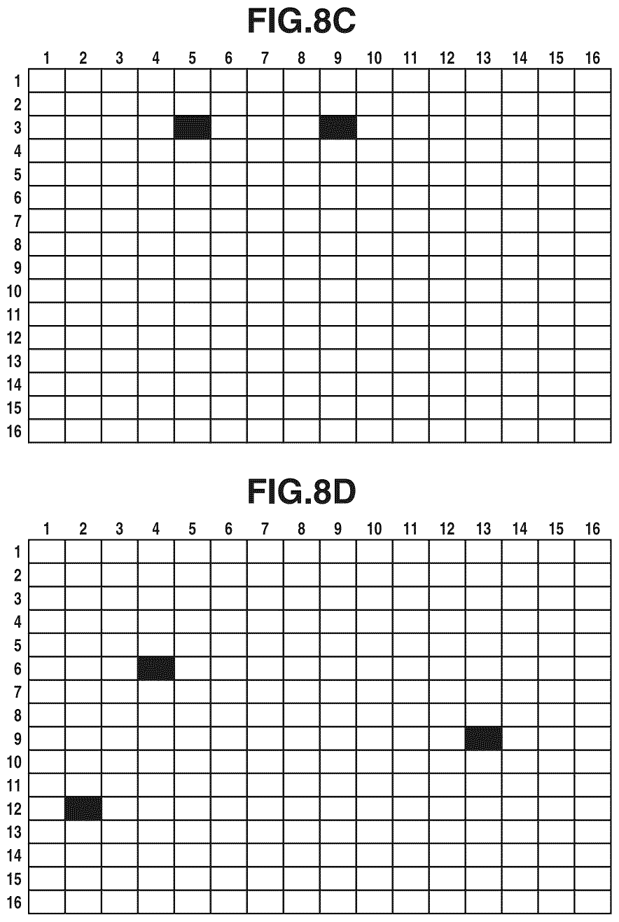

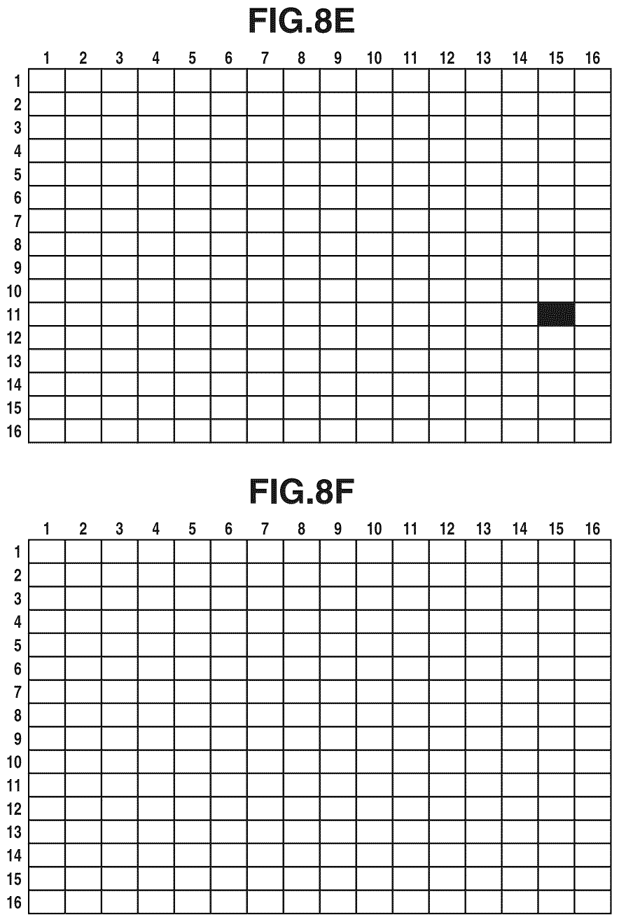

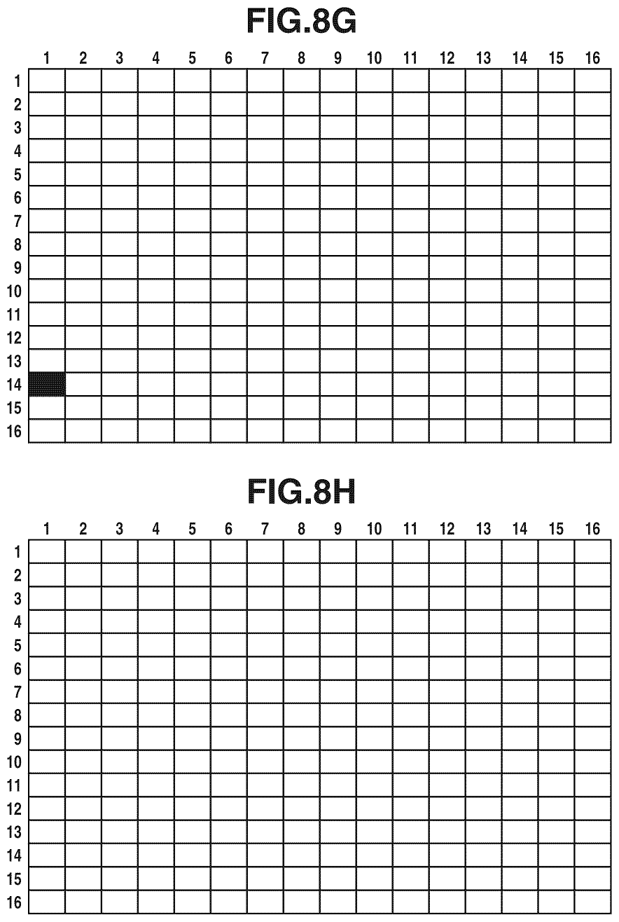

For the sake of comparison with the reaction solution dither pattern according to the at least one embodiment illustrated in FIG. 6E, FIG. 6F illustrates a reaction solution dither pattern generated using a different technique and/or without using the technique of the at least one embodiment illustrated in FIG. 6E. As an example, FIGS. 7A to 7F illustrate dot arrangements resulting when a uniform solid image of 10/256 gradation is input as an input image to the dither patterns of FIGS. 6A to 6F, respectively. Based on these results, FIGS. 8A to 8H illustrate positions where the colorant ink dots of the 10/256-gradation colorant ink solid images overlap with the reaction solution dots of the 10/256-gradation reaction solution solid images. FIGS. 8A to 8D illustrate the overlaps of the cyan, magenta, yellow, and black dots with the reaction solution dots when the reaction solution dither pattern (e.g., the reaction solution dither pattern according to the at least one embodiment illustrated in FIG. 6E) according to one or more of the above-described embodiments is used. It may be seen that the numbers of overlapping dots of the respective colors are 3, 3, 2, and 3.

FIGS. 8E to 8H illustrate the overlaps of the cyan, magenta, yellow, and black dots with the reaction solution dots when the reaction solution dither pattern generated using one or more different techniques and/or without using the technique(s) of one or more of the above-described embodiments is used. It may be seen that the numbers of overlapping dots of the respective colors are 1, 0, 1, and 0. This comparison shows that more dots overlap when the reaction solution dither pattern (such as, but not limited to, the reaction solution dither pattern according to the at least one embodiment illustrated in FIG. 6E) of the one or more of the above-described embodiments is used as illustrated in FIGS. 8A to 8D than when the reaction solution dither pattern generated using one or more different techniques and/or without using the technique(s) of one or more of the above-described embodiments is used as illustrated in FIGS. 8E to 8H.

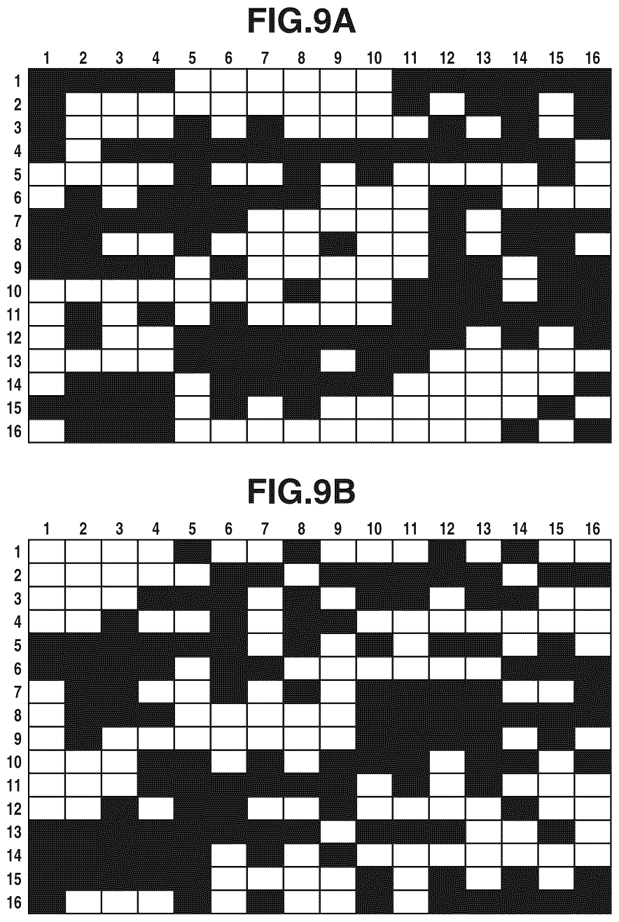

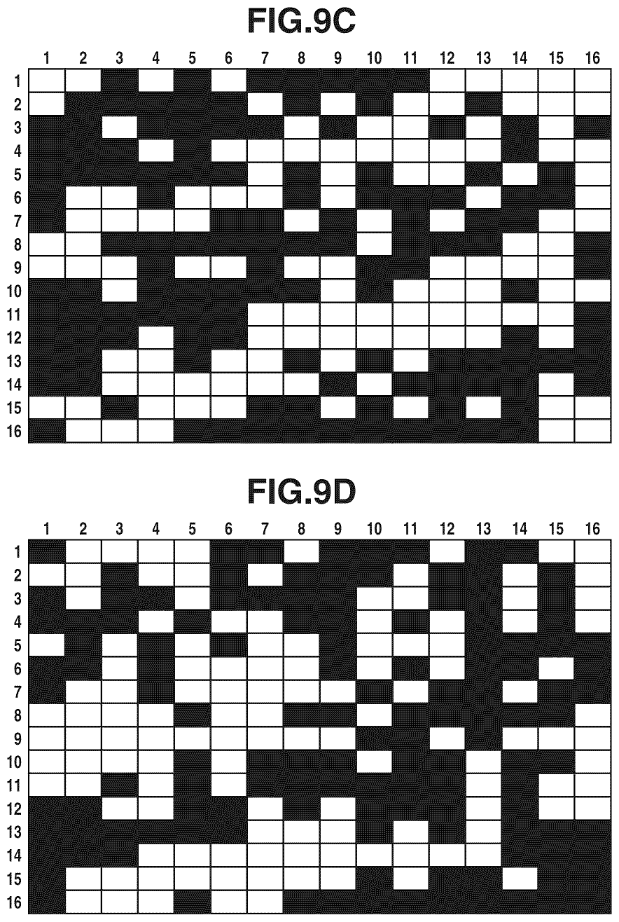

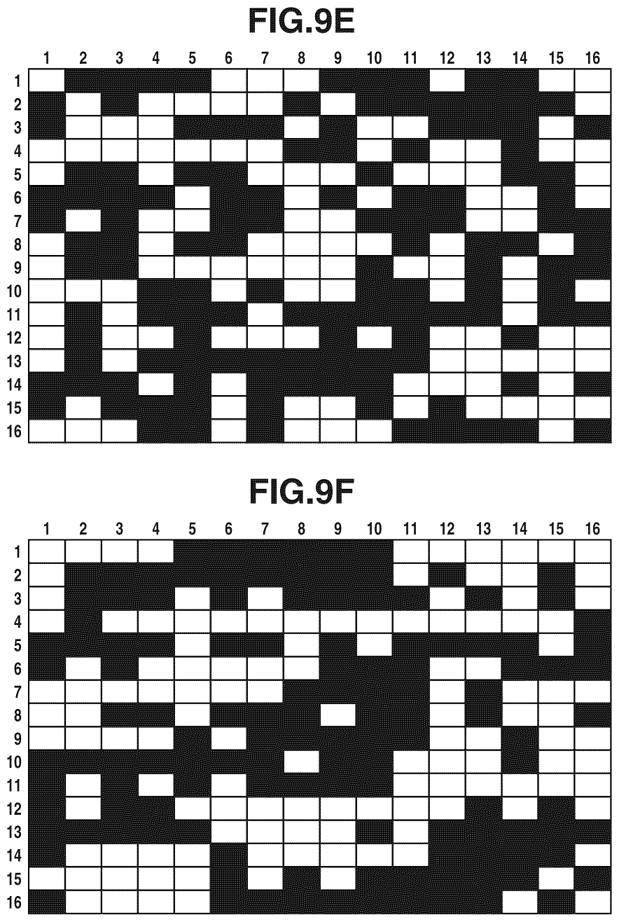

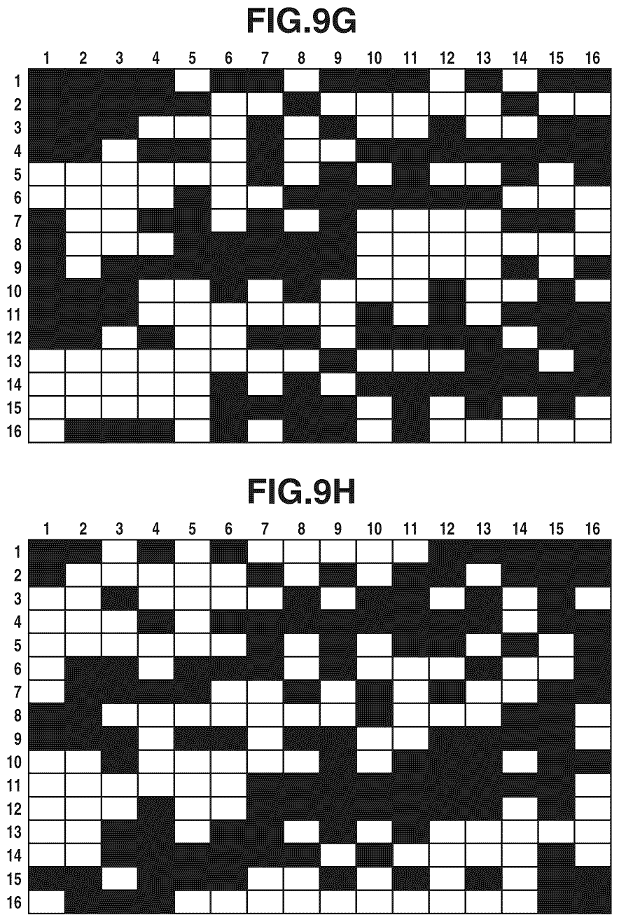

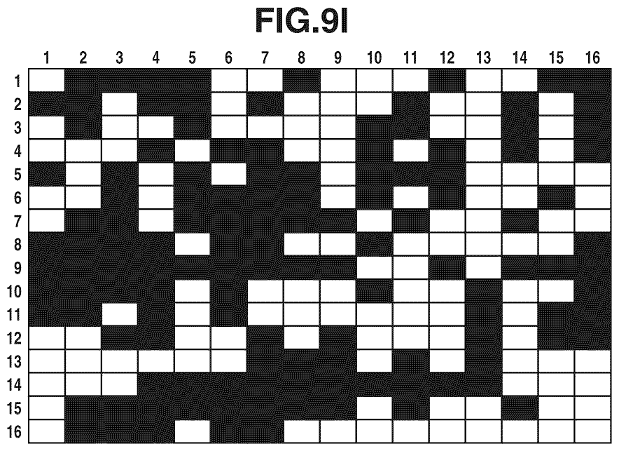

According to one or more embodiments, the overlapping of dots at lower gradation levels of the colorant inks and lower gradation levels of the reaction solution is enhanced. This provides the following dot overlapping characteristics depending on the gradation level. That is, more dots overlap at levels lower than the gradation centers of the colorant inks and levels lower than the gradation center of the reaction solution, compared to at levels higher than the gradation centers of the colorant inks and levels lower than the gradation center of the reaction solution. FIGS. 9A, 9B, 9C, 9D, and 9E illustrate the dot arrangements of the colorant inks and reaction solution at gradations lower than the gradation centers. Since one or more embodiments of the present disclosure are capable of expressing a total of 256 levels, the dot arrangements at the 128th levels that are the gradation centers are illustrated here. FIGS. 9F, 9G, 9H, and 9I illustrate the dot arrangements of the colorant inks at levels higher than the gradation centers.

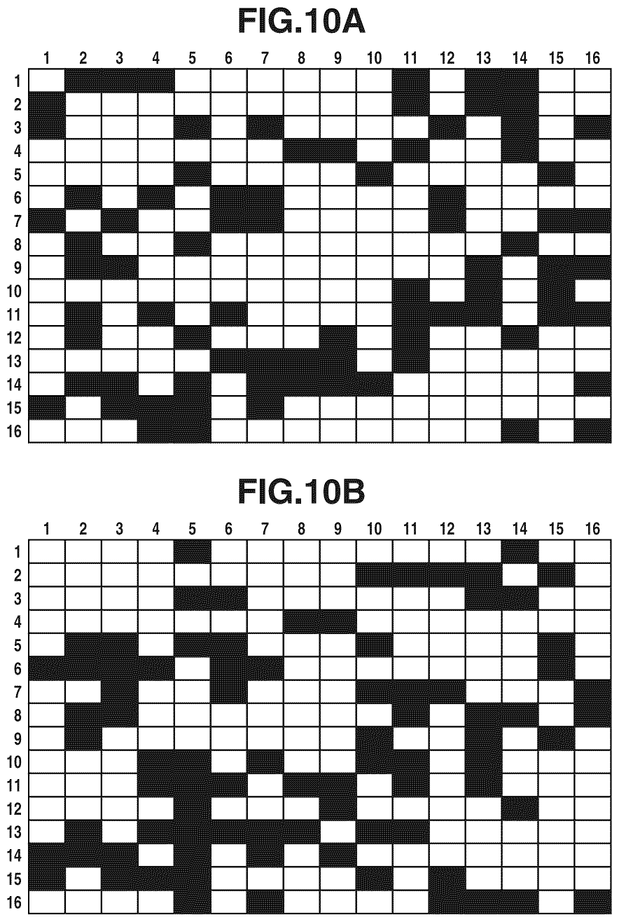

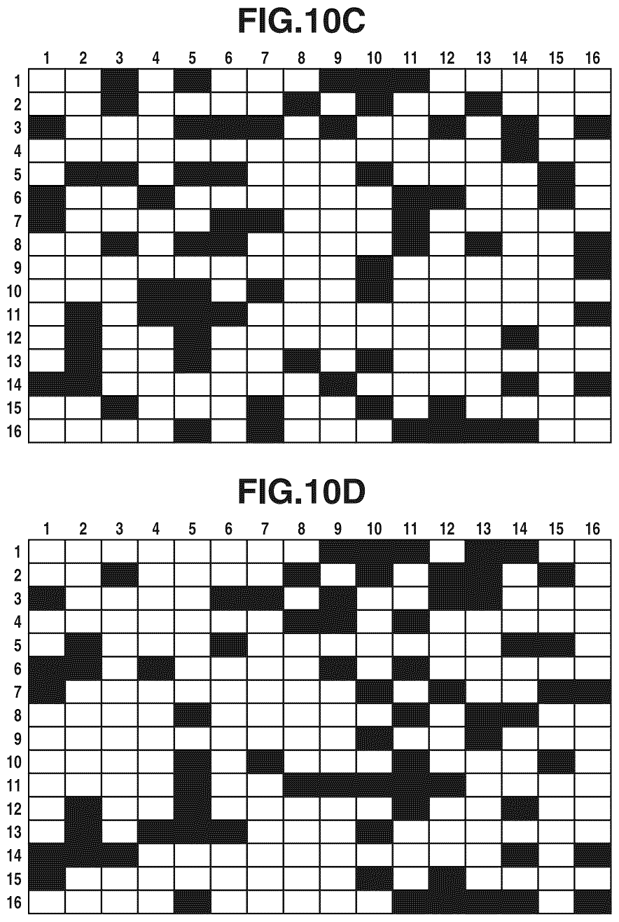

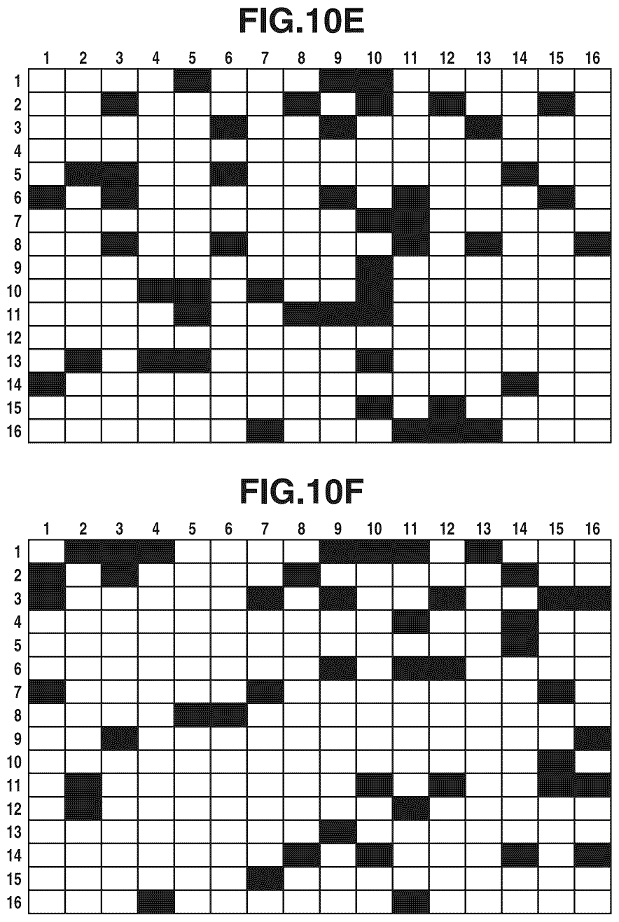

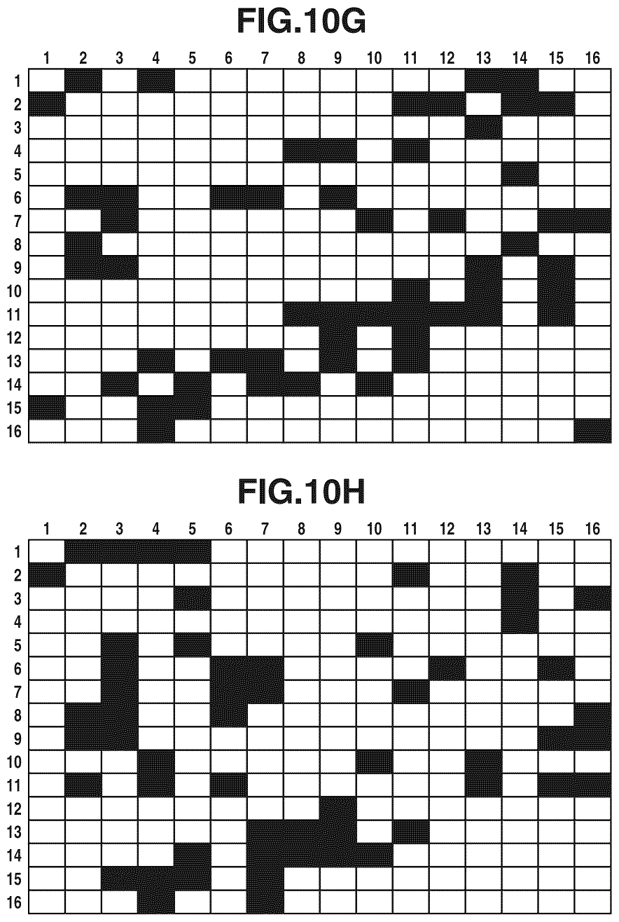

More specifically, FIGS. 9F, 9G, 9H, and 9I illustrate the inverted dot arrangements of FIGS. 9A, 9B, 9C, and 9D. FIGS. 10A, 10B, 10C, and 10D illustrate dot overlaps between the colorant ink dot arrangements of FIGS. 9A, 9B, 9C, and 9D at lower levels and the reaction solution dot arrangement of FIG. 9E at lower levels in one or more embodiments.

FIGS. 10E, 10F, 10G, and 10H illustrate dot overlaps between the colorant ink dot arrangements of FIGS. 9F, 9G, 9H, and 9I at higher levels and the reaction solution dot arrangement of FIG. 9E at lower levels in one or more embodiments. The numbers of dots overlapping between the colorant ink dot arrangements of FIGS. 9A, 9B, 9C, and 9D at lower levels and the reaction solution dot arrangement of FIG. 9E at lower levels are 81, 84, 72, and 73, respectively. On the other hand, the numbers of dots overlapping between the colorant ink dot arrangements of FIGS. 9F, 9G, 9H, and 9I at higher levels and the reaction solution dot arrangement of FIG. 9E at lower levels are 48, 45, 57, and 56, respectively. It may be seen that more dots overlap between the colorant ink dot arrangements at lower levels and the reaction solution dot arrangement at lower levels, compared to between the colorant ink dot arrangements at higher levels and the reaction solution dot arrangement at lower levels. According to one or more embodiments, the contact probability with the colorant inks may thus be increased with smaller amounts of reaction solution, which may suppress image defects due to reaction solution beading.

As described above, in one or more embodiments, the positions of the thresholds in the colorant ink dither patterns are identified in the ascending order of the thresholds, and thresholds are set for the same positions in the reaction solution dither pattern in ascending order. Image formation using the reaction solution dither pattern generated in such a manner may suppress image defects due to reaction solution beading while suppressing image defects such as density unevenness and textures due to variations in the dot arrangements of the reaction solution for respective recording scans.

### Configuration(s) for One or More Additional Embodiments

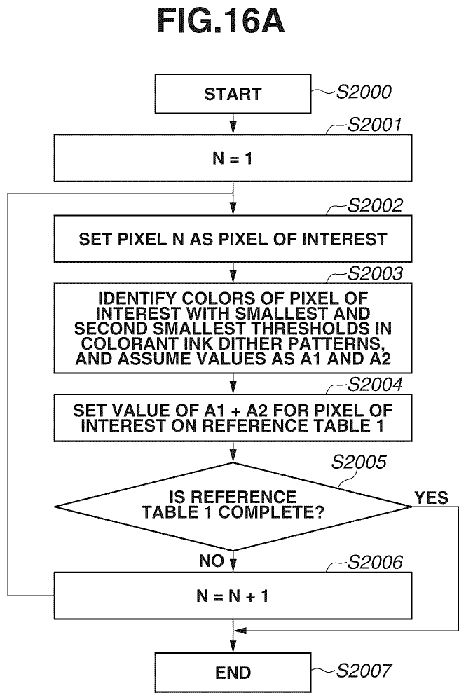

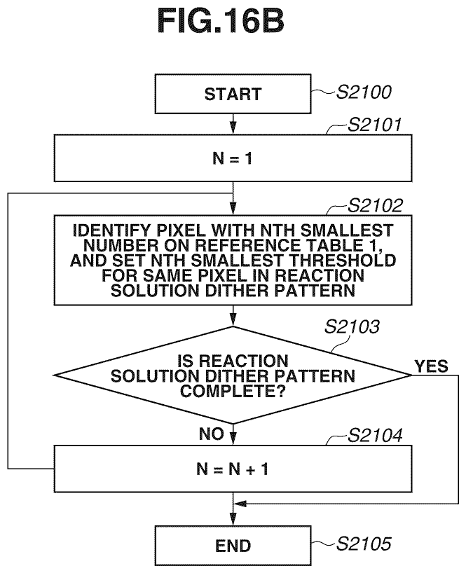

One or more additional embodiments, while based on the above-described embodiment example(s), describe a different example or examples of the method for generating a reaction solution dither pattern with reference to the flowcharts of FIGS. 16A and 16B.

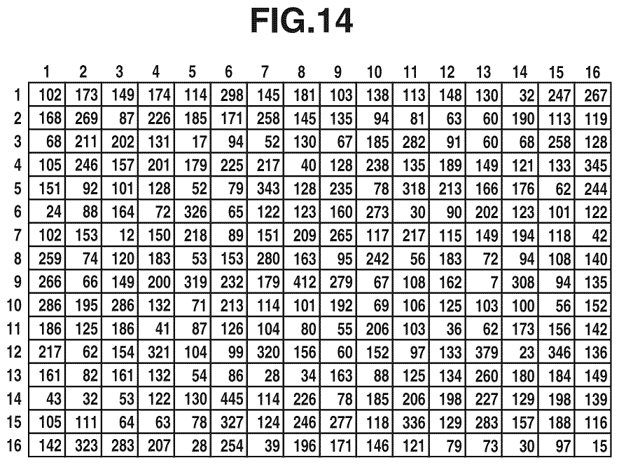

In FIG. 16A, reference table 1 is generated based on colorant ink dither patterns. In step S2000, a halftoning unit J0005 starts generation of reference table 1. In step S2001, the halftoning unit J0005 sets natural number N to “1”. In step S2002, the halftoning unit J0005 sets pixel N (=1) as a pixel of interest. In one or more embodiments, pixel 1 shall refer to the pixel at (column 1, row 1), and pixel N shall then move to adjacent pixels. In step S2003, the halftoning unit J0005 identifies the colors of the pixel of interest with the smallest and second smallest thresholds in the colorant ink dither patterns, and assumes the values as A1 and A2, respectively. In step S2004, the halftoning unit J0005 sets the value of A1+A2 for the pixel of interest on reference table 1. FIG. 14 illustrates reference table 1 for generating a reaction solution dither pattern according to one or more embodiments. Reference table 1 lists the results of application of arithmetic operations to be described below to the thresholds of the pixels in the four colorant ink dither patterns illustrated in FIGS. 6A to 6D.

The value at (column 1, row 1) of FIG. 14 is the sum of the smallest and second smallest thresholds among the thresholds at (column 1, row 1) in FIGS. 6A to 6D. The smallest threshold is “49” in FIG. 6A, and the second smallest threshold is “53” in FIG. 6B, and the sum “102” is thus entered at (column 1, row 1) in FIG. 14. FIG. 14 is obtained by applying similar arithmetic operations to all the pixel positions. The reference data of FIG. 14 shows the tendency that the smaller the value of the pixel, the more likely colorant ink dots are to be formed. In step S2005, if reference table 1 is complete (YES in step S2005), the processing proceeds to step S2007 and ends. If not (NO in step S2005), the processing returns to step S2002.

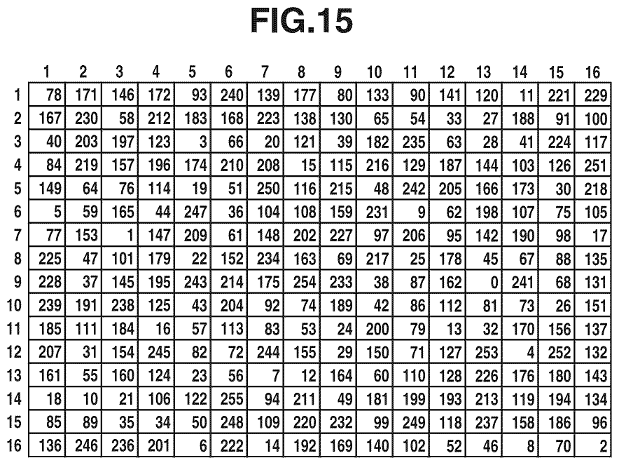

In FIG. 16B, a reaction solution dither pattern is generated based on reference table 1. In step S2100, the halftoning unit J0005 starts generation of the reaction solution dither pattern. In step S2101, the halftoning unit J0005 sets natural number N to “1”. In step S2102, the halftoning unit J0005 identifies the pixel with the Nth (N=1) smallest value on reference table 1, and sets the Nth (N=1) smallest threshold “0” for the pixel at the same position in the reaction solution dither pattern. In step S2103, if the reaction solution dither pattern is complete (YES in step S2103), the processing proceeds to step S2105 and ends. If not (NO in step S2103), the processing returns to step S2102. FIG. 15 illustrates the reaction solution dither pattern according to one or more embodiments, generated based on reference table 1 of FIG. 14.

The positions of the values in reference table 1 of FIG. 14 are identified in ascending order of the values, and thresholds are set for the same positions in the reaction solution dither pattern in ascending order. The smallest value in the reference data of FIG. 14 is “7” at (column 9, row 13), and the smallest threshold “0” is thus set at (column 9, row 13) in the reaction solution dither pattern of FIG. 15. The next smallest value in FIG. 14 is “12” at (column 7, row 3), and the next smallest threshold “1” is thus set at (column 7, row 3) in the reaction solution dither pattern of FIG. 15. Subsequently, positions are similarly identified in ascending order of the values in the reference data of FIG. 14, and thresholds are set at the same positions in the reaction solution dither pattern of FIG. 15 in ascending order.

As described above, the reference data is generated from the thresholds in the colorant ink dither patterns to identify positions where colorant ink dots are likely to be formed, and the thresholds in the reaction solution dither pattern are set in order from the positions where the colorant ink dots are more likely to be formed. Image formation using the reaction solution dither pattern generated in such a manner may suppress image defects due to reaction solution beading.

### Configurations of One or More Further Embodiments

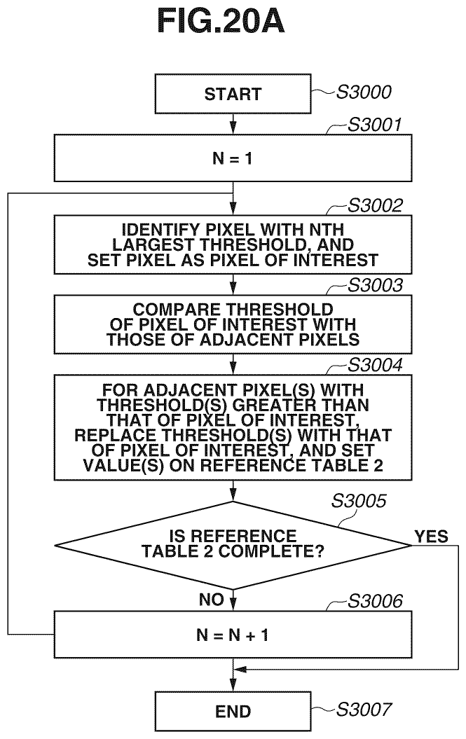

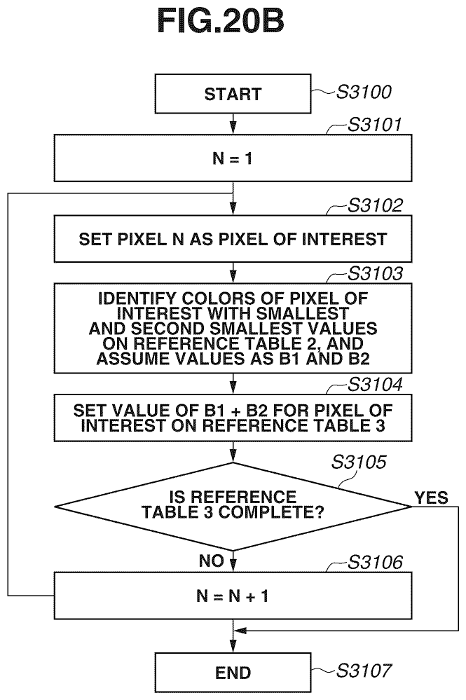

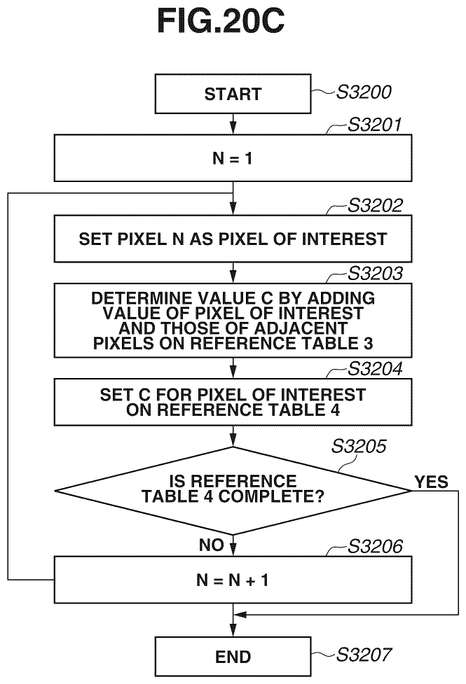

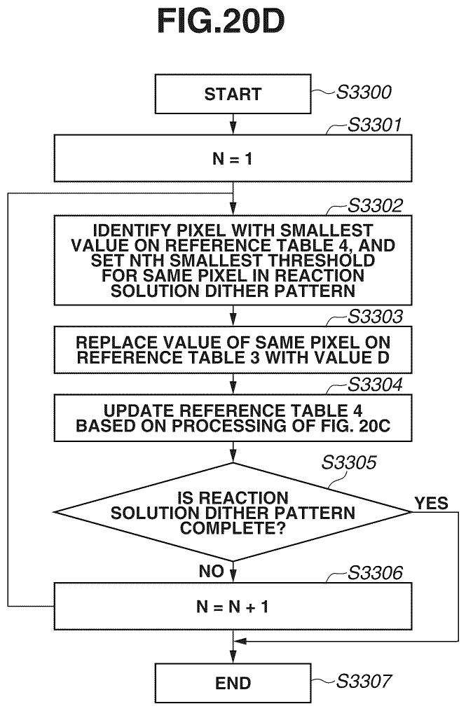

One or more further embodiments, while based on the example(s) described in the one or more additional embodiments, describe a different example of the method for generating a reaction solution dither pattern. One or more embodiments deals with a case where the dot size is larger than the pixel size of the dither patterns, and a reaction solution dither pattern is generated by determining the degree of dot overlap in consideration of the dot size, which is approximately three pixels vertically and three pixels horizontally. The method for generating the reaction solution dither pattern will now be described with reference to the flowcharts of FIGS. 20A, 20B, 20C, and 20D.

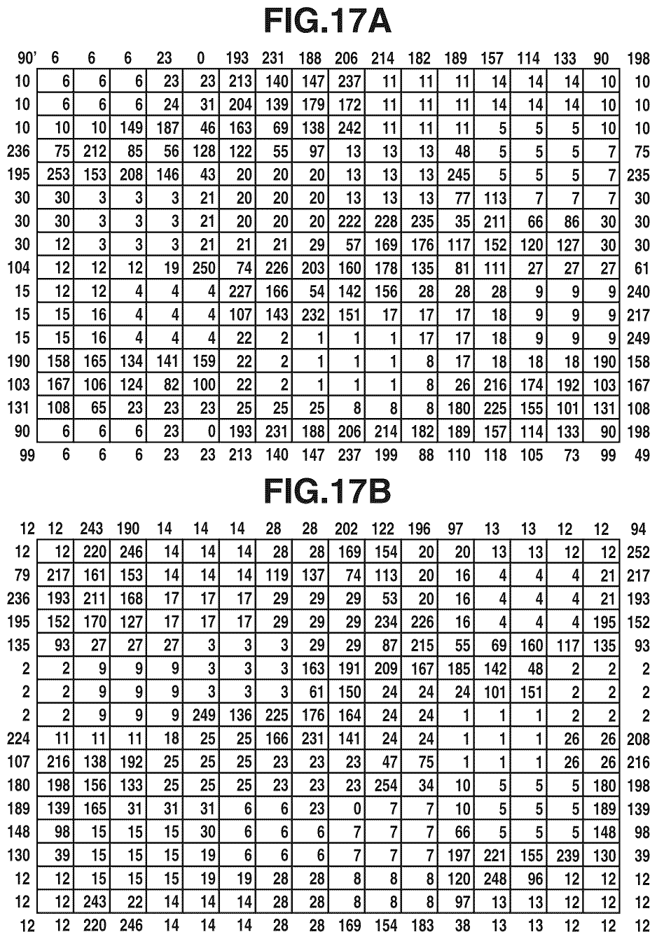

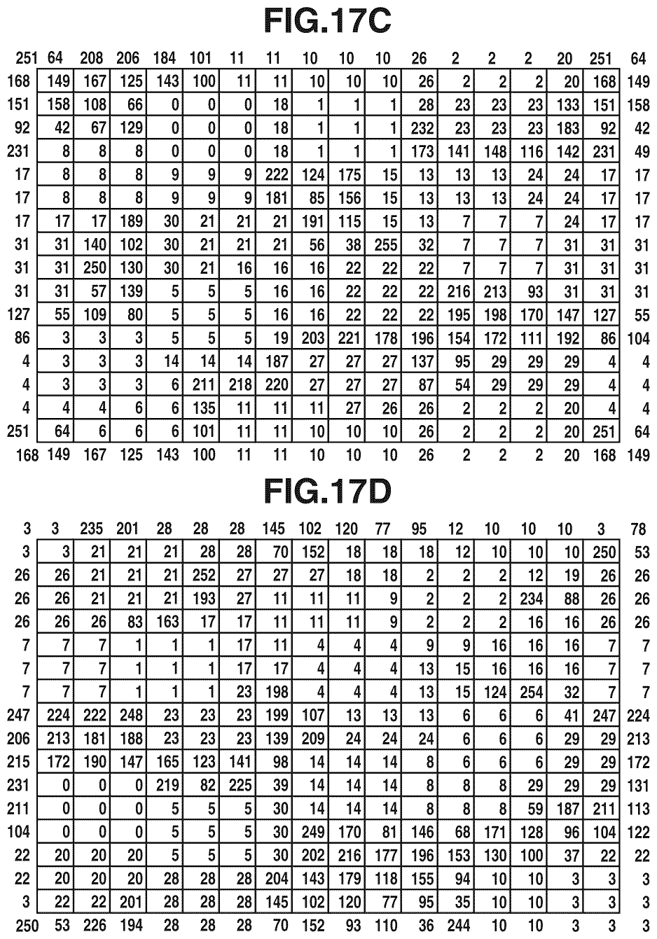

In FIG. 20A, reference table 2 is generated for each color, based on the dither patterns of the respective colorant inks. In step S3000, a halftoning unit J0005 starts generation of reference table 2. In step S3001, the halftoning unit J0005 sets natural number N to “1”. In step S3002, the halftoning unit J0005 identifiers the pixel with the Nth (N=1) largest threshold in the dither pattern of each colorant ink, and assumes the identified pixel as a pixel of interest. In step S3003, the halftoning unit J0005 compares the threshold of the pixel of interest with those of adjacent pixels. In step S3004, for an adjustment pixel or pixels found to have a threshold greater than that of the pixel of interest as a result of the comparison in step S3004, the halftoning unit J0005 replaces the threshold(s) with that of the pixel of interest, and sets the value(s) to reference table 2. In step S3005, if reference table 2 is complete (YES in step S3005), the processing proceeds to step S3007. If not (NO in step S3005), the processing returns to step S3002. FIGS. 17A to 17D illustrate reference tables 2 for the respective color inks, generated based on the flowchart of this FIG. 20A. FIGS. 17A to 17D illustrate reference data obtained by extending the threshold of each pixel in the four colorant ink dither patterns illustrated in FIGS. 6A to 6D to a size of 3×3. As the coverages of the thresholds are extended, the areas of FIGS. 17A to 17D are extended from 16×16 to 18×18 to cover adjacent pixels.

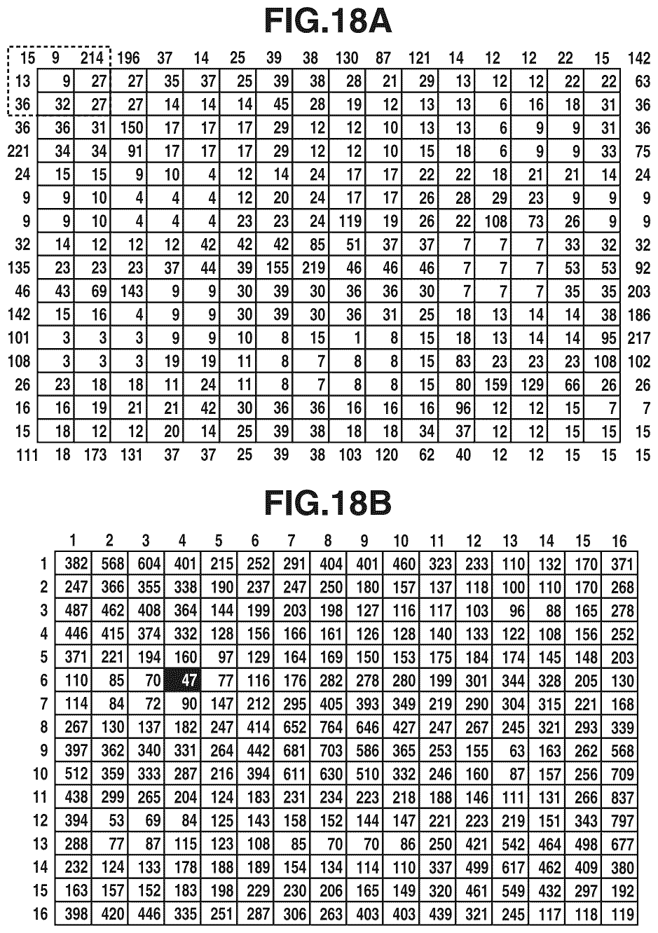

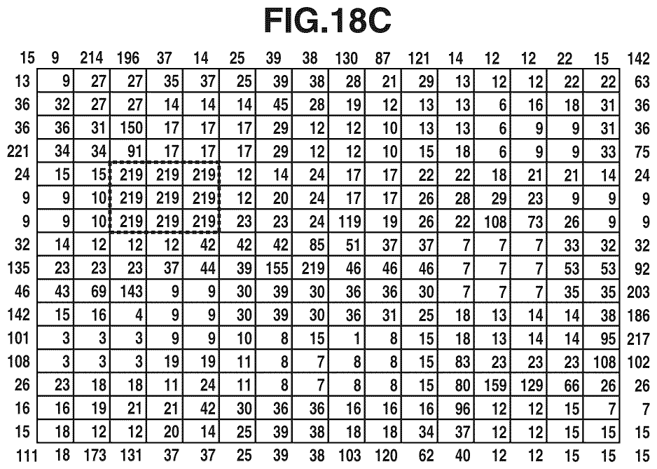

Next, in FIG. 20B, reference table 3 is generated based on reference tables 2 for the respective colorant inks. In step S3100, the halftoning unit J0005 starts generation of reference table 3. In step S3101, the halftoning unit J0005 sets natural number N to “1”. In step S3102, the halftoning unit J0005 sets pixel N (=1) as the pixel of interest. In one or more embodiments, pixel 1 refers to the pixel at (column 1, row 1), and pixel N then moves to adjacent pixels. In step S3103, the halftoning unit J0005 identifies the colors of the pixel of interest with the smallest and second smallest values on reference tables 2 for the respective colorant inks, and assumes the values as B1 and B2, respectively. In step S3104, the halftoning unit J0005 sets the value of B1+B2 for the pixel of interest on reference table 3. FIG. 18A illustrates reference table 3 for generating a reaction solution dither pattern according to one or more embodiments.

Reference table 3 lists values each obtained by adding the smallest and second smallest thresholds among the thresholds for the pixel at the same position in FIGS. 17A to 17D. The smallest threshold is “3” in FIG. 17D and the second smallest threshold is “12” in FIG. 17B, and the sum “15” is thus entered at the same pixel position in FIG. 18A. In step S3205, if reference table 3 is complete (YES in step S3205), the processing proceeds to step S3207 and ends. If not (NO in step S3205), the processing returns to step S3202. FIG. 18A illustrates reference table 3 obtained by applying similar arithmetic operations to all the pixel positions.

Next, in FIG. 20C, reference table 4 is generated based on reference table 3. In step S3200, the halftoning unit J0005 starts generation of reference table 4. In step S3201, the halftoning unit J0005 sets natural number N to “1”.

In step S3202, the halftoning unit J0005 sets pixel N (=1) as the pixel of interest. In step S3203, the halftoning unit J0005 determines a value C by adding the value of the pixel of interest and those of adjacent pixels on reference table 3. In step S3204, the halftoning unit J0005 sets C for the pixel of interest on reference table 4. FIG. 18B illustrates reference table 4, where the total sum of the thresholds in the 3×3 area centered at the pixel of interest on reference table 3 of FIG. 18A is entered for each pixel. The value “382” entered at (column 1, row 1) of FIG. 18B illustrating reference table 4 is the total sum of the thresholds of the 3 ×3 pixels surrounded by the dotted line in FIG. 18A illustrating reference table 3. Subsequently, the total sum in the 3×3 area about each pixel of interest in FIG. 18A is similarly set for the pixel of interest in FIG. 18B illustrating reference table 4.

Next, in FIG. 20D, a reaction solution dither pattern is generated based on reference table 4.

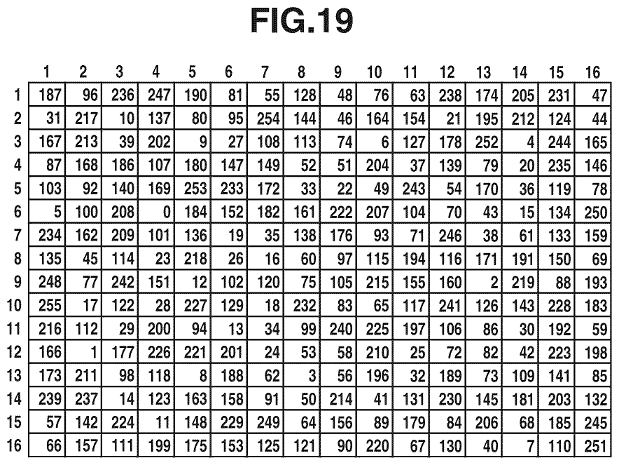

In step S3300, the halftoning unit J0005 starts generation of the reaction solution dither pattern. In step S3301, the halftoning unit J0005 sets natural number N to “1”. In step S3302, the halftoning unit J0005 identifies the pixel with the smallest value on reference table 4, and sets the Nth (N=1) smallest threshold for the pixel at the same position in the reaction solution dither pattern. The pixel with the smallest value in FIG. 18B illustrating reference table 4 is found at (column 6, row 4) with “47”. Based on this, the smallest threshold “0” in the reaction solution dither pattern of FIG. 19 according to one or more embodiments is set at (column 6, row 4). In step S3303, the halftoning unit J0005 replaces the value of the pixel at the same position on reference table 3 with a value D. In step S3304, the halftoning unit J0005 updates reference table 4 based on the flowchart of FIG. 20C.

In one or more embodiments, for convenience, the values in the 3×3 area centered at (column 6, row 4) of FIG. 18A illustrating reference table 3 are replaced with a value D of “219”, which is the largest value on the table, whereby reference table 4 updated based on the flowchart of FIG. 20C and reference table 3 illustrated in FIG. 18 are obtained. In step S3305, if the reaction solution dither pattern is complete (YES in step S3305), the processing proceeds to step S3307 and ends. If not (NO in step S3305), the processing returns to step S3302. Similar arithmetic operations are subsequently repeated, like calculating the total sum of the thresholds in the 3×3 area centered at the pixel of interest in FIG. 18C illustrating the updated reference table 3, identifying the pixel with the smallest value, and setting the second smallest threshold “1” in the reaction solution dither pattern of FIG. 19.

As described above, the coverages of the thresholds in the colorant ink dither patterns are extended, based on which reference data is generated to identify positions where colorant ink dots are likely to be formed, and the thresholds of the reaction solution dither pattern are set in order from the positions where reaction solution dots are more likely to overlap colorant ink dots. Image formation using the reaction solution dither pattern generated in such a manner may suppress image defects due to reaction solution beading.

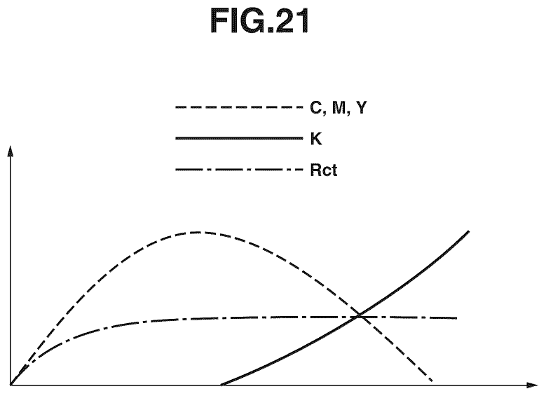

In one or more of the above-described embodiments, all the cyan, magenta, yellow, and black dither patterns are described to be referred to in generating the reaction solution dither pattern. However, the dither patterns of all the colors do not need to be referred to. FIG. 21 is a graph illustrating how the amounts of color inks used vary as print data changes from white to black. The left end of the horizontal axis of the graph represents the case where the print data is white, and the right end the case where the print data is black. As may be seen from the graph, the amount of reaction solution used increases as the amounts of color inks increase. In areas where the print data is close to white, the amounts of cyan, magenta, and yellow inks used are small and the amount of the reaction solution used is also small. On the other hand, black ink starts to be used in situations where cyan, magenta, and yellow inks are already being used heavily, and the amount of reaction solution used is thus large. The reaction solution dither pattern may therefore be generated to increase the contact probability between colorant ink dots and reaction solution dots by referring to only the dither patterns of the cyan, magenta, and yellow inks, of which the contact probability of with the reaction solution is to be preferentially increased.

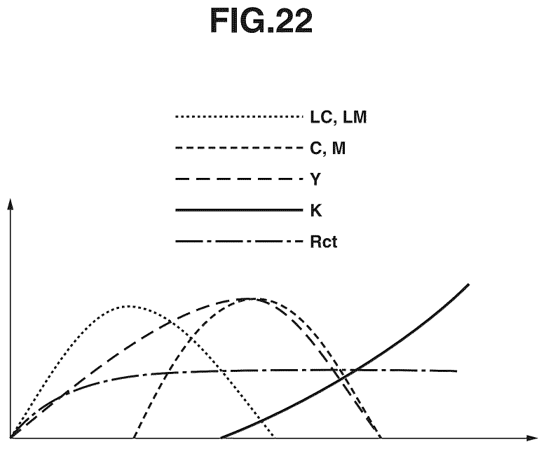

In one or more of the above-described embodiments, the recording apparatus 100 is described to use cyan, magenta, yellow, and black, four colorant inks as the colorant inks. However, the colorant inks may be configured otherwise. For example, the recording apparatus 100 may be configured to use six color inks including light cyan (LC) and light magenta (LM) inks of different colorant densities in addition to the foregoing four color inks. While the dither patterns of all the six colors may be referred to in generating the reaction solution dither pattern, the dither patterns of only some of the colors may be referred to. FIG. 22 is a diagram illustrating how the amounts of color inks used vary as the print data changes from white to black, when the six colorant inks are used. As may be seen from the graph, the amount of reaction solution used increases with the amounts of colorant inks. In areas where the print data is close to white, the amounts of light cyan, light magenta, and yellow inks with low colorant densities are small and the amount of reaction solution used is also small. On the other hand, cyan and magenta inks with high colorant densities start to be used in situations where light cyan, light magenta, and yellow inks with low colorant densities are already being used heavily, and the amount of reaction solution used is thus large. Furthermore, black ink starts to be used in situations where cyan, magenta, and yellow inks are already being used heavily, and the amount of reaction solution used is thus large. The retroreflection dither pattern may therefore be generated to increase the contact probability between colorant ink dots and reaction solution dots by referring to only the dither patterns of light cyan, light magenta, and yellow inks, of which the contact probability with the reaction solution is to be preferentially increased.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159227, filed Sep. 13, 2024, and Japanese Patent Application No. 2025-142202, filed Aug. 28, 2025, which are hereby incorporated by reference herein in their entirety.

What is claimed is:

1. A recording apparatus comprising:
a recording unit including a plurality of nozzle rows including a first nozzle row where a plurality of nozzles operating to apply colorant ink containing a colorant is arranged and a second nozzle row where a plurality of nozzles operating to apply a reaction solution to react with the colorant is arranged; and
one or more processors that operate to:
determine an amount of the colorant ink and an amount of the reaction solution to be applied to a recording medium based on input image data; and
(i) determine a dot arrangement of the colorant ink based on the amount of the colorant ink and a first dither pattern corresponding to the colorant ink, and (ii) determine a dot arrangement of the reaction solution based on the amount of the reaction solution and a second dither pattern corresponding to the reaction solution,
wherein a first number, which is a number of pixels overlapping between a dot arrangement with gradation values smaller than a median of all gradations in the first dither pattern and a dot arrangement with gradation values smaller than a median of all gradations in the second dither pattern, is greater than a second number, which is a number of pixels overlapping between a dot arrangement with gradation values greater than the median of all the gradations in the first dither pattern and the dot arrangement with the gradation values smaller than the median of all the gradations in the second dither pattern.

2. The recording apparatus according to claim 1, wherein the recording unit includes a nozzle row that operates to apply a cyan ink containing a cyan colorant, a nozzle row that operates to apply a magenta ink containing a magenta colorant, a nozzle row that operates to apply a yellow ink containing a yellow colorant, and a nozzle row that operates to apply a black ink containing a black colorant.

3. The recording apparatus according to claim 2, wherein the one or more processors operate to: (i) determine a dot arrangement of the cyan ink based on a dither pattern corresponding to the cyan ink, (ii) determine a dot arrangement of the magenta ink based on a dither pattern corresponding to the magenta ink, (iii) determine a dot arrangement of the yellow ink based on a dither pattern corresponding to the yellow ink, and (iv) determine a dot arrangement of the black ink based on a dither pattern corresponding to the black ink.

4. The recording apparatus according to claim 3, wherein a number of pixels overlapping between a dot arrangement with gradation values smaller than a median of all gradations in the dither pattern corresponding to the black ink and the dot arrangement with the gradation values smaller than the median of all the gradations in the second dither pattern is one less than a number of pixels overlapping between a dot arrangement with gradation values smaller than a median of all gradation in the dither pattern corresponding to the cyan ink and the dot arrangement with the gradation values smaller than the median of all the gradations in the second dither pattern.

5. The recording apparatus according to claim 3,
wherein a first reference table is a new table obtained by applying an arithmetic operation to each pixel, the arithmetic operation including determining a sum of thresholds for two or more colors of smallest thresholds among thresholds for pixels at a same position in the respective dither patterns corresponding to the plurality of colorant inks and setting the sum for a pixel at the same position, and
wherein thresholds for respective pixels of the second dither pattern are set in ascending order from pixels at same positions as pixels where the first reference table has smaller values.

6. The recording apparatus according to claim 3,
wherein a first arithmetic operation is an arithmetic operation of identifying a pixel with a largest threshold in each of the dither patterns corresponding to the plurality of colorant inks, setting the identified pixel as a pixel of interest, comparing a threshold for a pixel adjacent to the pixel of interest with the threshold for the pixel of interest, and in a case where the threshold for the adjacent pixel is greater than the threshold for the pixel of interest, replacing the threshold for the adjacent pixel with the threshold for the pixel of interest,
wherein a second reference table for each color is a table for each color, obtained by repeating the first arithmetic operation in order from pixels with greater thresholds in each of the dither patterns corresponding to the plurality of colorant inks,
wherein a third reference table is a new table obtained by applying an arithmetic operation to each pixel, the arithmetic operation including determining a sum of thresholds for two or more colors of smallest thresholds among thresholds for pixels at a same position on the second reference tables for the plurality of colorant inks and setting the sum for a pixel at the same position,
wherein a fourth reference table is a new table obtained by setting each pixel on the third reference table as a pixel of interest and setting a sum of values of the pixel of interest and a pixel adjacent to the pixel of interest for a pixel at a same position,
wherein a threshold of the second dither pattern is set by setting a smallest threshold for a pixel at a same position in the second dither pattern as a pixel with a smallest value on the fourth reference table, and updating the third reference table by replacing a value of the pixel at the same position on the third reference table with a different value greater than its original value,
wherein the fourth reference table is updated by setting each pixel on the updated third reference table as a pixel of interest and setting a sum of values of the pixel of interest and a pixel adjacent to the pixel of interest for a pixel at a same position,
wherein a next smallest threshold in the second dither pattern is set at a pixel position of the fourth reference table where a smallest value is, and
wherein thresholds for respective pixels of the second dither pattern are set by repeatedly updating the third reference table and the fourth reference table.

7. The recording apparatus according to claim 1, wherein thresholds for respective pixels of the second dither pattern are set in ascending order from pixel positions where the first dither pattern has smaller thresholds.
